(19) United States
(12) Patent Application Publication
(10) Pub. No.: US 2025/0253991 A1
(43) Pub. Date: Aug. 7, 2025

(54) SMALL DATA TRANSMISSIONS FOR MULTIPLE TRANSMISSION RECEPTION POINTS

(71) Applicant: QUALCOMM Incorporated, San Diego, CA (US)

(72) Inventors: Ruiming ZHENG, Beijing (CN); Ozcan OZTURK, San Diego, CA (US); Xiaoxia ZHANG, San Diego, CA (US); Mostafa KHOSHNEVISAN, San Diego, CA (US)

(21) Appl. No.: 18/854,753

(22) PCT Filed: Jun. 30, 2022
(86) PCT No.: PCT/CN2022/102678

§ 371 Date: Oct. 7, 2024

(51) Int. Cl. H04L 5/00; H04B 7/06

(52) U.S. Cl. CPC H04L 5/0035; H04B 7/06952; H04L 5/0023

(57) ABSTRACT

Various aspects of the present disclosure generally relate to wireless communication. In some aspects, a user equipment (UE) may receive, from a network node, a configuration that indicates a plurality of beams. The UE may transmit, to the network node, a multiple transmission reception point (TRP) (multi-TRP) request message, wherein the multi-TRP request message indicates multiple qualified beams from the plurality of beams. The UE may perform, with the network node, a multi-TRP small data transmission (SDT) based at least in part on the multiple qualified beams indicated by the multi-TRP request message. Numerous other aspects are described.

### FIELD OF THE DISCLOSURE

Aspects of the present disclosure generally relate to wireless communication and to techniques and apparatuses for small data transmissions (SDTs) for multiple transmission reception points (TRPs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network node, a configuration that indicates a plurality of beams; transmit, to the network node, a multiple transmission reception point (TRP) (multi-TRP) request message, wherein the multi-TRP request message indicates multiple qualified beams from the plurality of beams; and perform, with the network node, a multi-TRP small data transmission (SDT) based at least in part on the multiple qualified beams indicated by the multi-TRP request message.

In some implementations, an apparatus for wireless communication at a UE includes a memory and one or more processors, coupled to the memory, configured to: receive, from a network node, a radio resource control (RRC) release message that indicates a TRP resource or beam configuration, wherein the TRP resource or beam configuration indicates multiple beams associated with multiple TRPs of the network node, respectively; and perform, with the network node, a multi-TRP SDT based at least in part on the TRP resource or beam configuration.

In some implementations, an apparatus for wireless communication at a network node includes a memory and one or more processors, coupled to the memory, configured to: transmit, to a UE, a configuration that indicates a plurality of beams; receive, from the UE, a multi-TRP request message, wherein the multi-TRP request message indicates multiple qualified beams from the plurality of beams; and perform, with the UE, a multi-TRP SDT based at least in part on the multiple qualified beams indicated by the multi-TRP request message.

In some implementations, an apparatus for wireless communication at a network node includes a memory and one or more processors, coupled to the memory, configured to: transmit, to a UE, an RRC release message that indicates a TRP resource or beam configuration, wherein the TRP resource or beam configuration indicates multiple beams associated with multiple TRPs of the network node, respectively; and perform, with the UE, a multi-TRP SDT based at least in part on the TRP resource or beam configuration.

In some implementations, a method of wireless communication performed by a UE includes receiving, from a network node, a configuration that indicates a plurality of beams; transmitting, to the network node, a multi-TRP request message, wherein the multi-TRP request message indicates multiple qualified beams from the plurality of beams; and performing, with the network node, a multi-TRP SDT based at least in part on the multiple qualified beams indicated by the multi-TRP request message.

In some implementations, a method of wireless communication performed by a UE includes receiving, from a network node, an RRC release message that indicates a TRP resource or beam configuration, wherein the TRP resource or beam configuration indicates multiple beams associated with multiple TRPs of the network node, respectively; and performing, with the network node, a multi-TRP SDT based at least in part on the TRP resource or beam configuration.

In some implementations, a method of wireless communication performed by a network node includes transmitting, to a UE, a configuration that indicates a plurality of beams; receiving, from the UE, a multi-TRP request message, wherein the multi-TRP request message indicates multiple qualified beams from the plurality of beams; and performing, with the UE, a multi-TRP SDT based at least in part on the multiple qualified beams indicated by the multi-TRP request message.

In some implementations, a method of wireless communication performed by a network node includes transmitting, to a UE, an RRC release message that indicates a TRP resource or beam configuration, wherein the TRP resource or beam configuration indicates multiple beams associated with multiple TRPs of the network node, respectively; and performing, with the UE, a multi-TRP SDT based at least in part on the TRP resource or beam configuration.

In some implementations, a non-transitory computer-readable medium storing a set of instructions for wireless communication includes one or more instructions that, when executed by one or more processors of a UE, cause the UE to: receive, from a network node, a configuration that indicates a plurality of beams; transmit, to the network node, a multi-TRP request message, wherein the multi-TRP request message indicates multiple qualified beams from the plurality of beams; and perform, with the network node, a multi-TRP SDT based at least in part on the multiple qualified beams indicated by the multi-TRP request message.

In some implementations, a non-transitory computer-readable medium storing a set of instructions for wireless communication includes one or more instructions that, when executed by one or more processors of a UE, cause the UE to: receive, from a network node, an RRC release message that indicates a TRP resource or beam configuration, wherein the TRP resource or beam configuration indicates multiple beams associated with multiple TRPs of the network node, respectively; and perform, with the network node, a multi-TRP SDT based at least in part on the TRP resource or beam configuration.

In some implementations, a non-transitory computer-readable medium storing a set of instructions for wireless communication includes one or more instructions that, when executed by one or more processors of a network node, cause the network node to: transmit, to a UE, a configuration that indicates a plurality of beams; receive, from the UE, a multi-TRP request message, wherein the multi-TRP request message indicates multiple qualified beams from the plurality of beams; and perform, with the UE, a multi-TRP SDT based at least in part on the multiple qualified beams indicated by the multi-TRP request message.

In some implementations, a non-transitory computer-readable medium storing a set of instructions for wireless communication includes one or more instructions that, when executed by one or more processors of a network node, cause the network node to: transmit, to a UE, an RRC release message that indicates a TRP resource or beam configuration, wherein the TRP resource or beam configuration indicates multiple beams associated with multiple TRPs of the network node, respectively; and perform, with the UE, a multi-TRP SDT based at least in part on the TRP resource or beam configuration.

In some implementations, an apparatus for wireless communication includes means for receiving, from a network node, a configuration that indicates a plurality of beams; means for transmitting, to the network node, a multi-TRP request message, wherein the multi-TRP request message indicates multiple qualified beams from the plurality of beams; and means for performing, with the network node, a multi-TRP SDT based at least in part on the multiple qualified beams indicated by the multi-TRP request message.

In some implementations, an apparatus for wireless communication includes means for receiving, from a network node, an RRC release message that indicates a TRP resource or beam configuration, wherein the TRP resource or beam configuration indicates multiple beams associated with multiple TRPs of the network node, respectively; and means for performing, with the network node, a multi-TRP SDT based at least in part on the TRP resource or beam configuration.

In some implementations, an apparatus for wireless communication includes means for transmitting, to a UE, a configuration that indicates a plurality of beams; means for receiving, from the UE, a multi-TRP request message, wherein the multi-TRP request message indicates multiple qualified beams from the plurality of beams; and means for performing, with the UE, a multi-TRP SDT based at least in part on the multiple qualified beams indicated by the multi-TRP request message.

In some implementations, an apparatus for wireless communication includes means for transmitting, to a UE, an RRC release message that indicates a TRP resource or beam configuration, wherein the TRP resource or beam configuration indicates multiple beams associated with multiple TRPs of the apparatus, respectively; and means for performing, with the UE, a multi-TRP SDT based at least in part on the TRP resource or beam configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a mobile originated (MO) random access (RA) small data transmission (SDT), in accordance with the present disclosure.

FIG. 5 is a diagram illustrating an example of an MO configured grant (CG) SDT, in accordance with the present disclosure.

FIG. 6 is a diagram illustrating an example of a mobile terminated (MT) RA SDT, in accordance with the present disclosure.

FIGS. 7-9 are diagrams illustrating examples associated with SDTs for multiple transmission reception points (TRPs), in accordance with the present disclosure.

FIGS. 10-13 are diagrams illustrating example processes associated with SDTs for multiple TRPs, in accordance with the present disclosure.

FIGS. 14-15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

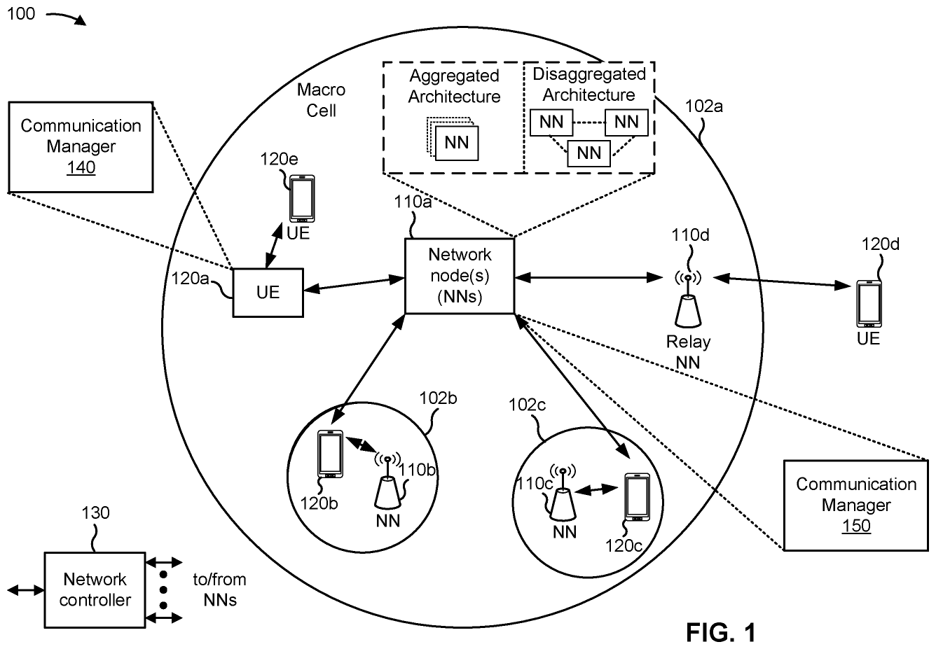

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node, a configuration that indicates a plurality of beams; transmit, to the network node, a multiple TRP (multi-TRP) request message, wherein the multi-TRP request message indicates multiple qualified beams from the plurality of beams; and perform, with the network node, a multi-TRP small data transmission (SDT) based at least in part on the multiple qualified beams indicated by the multi-TRP request message. As described in more detail elsewhere herein, the communication manager 140 may receive, from a network node, a radio resource control (RRC) release message that indicates a TRP resource or beam configuration, wherein the TRP resource or beam configuration indicates multiple beams associated with multiple TRPs of the network node, respectively; and perform, with the network node, a multi-TRP SDT based at least in part on the TRP resource or beam configuration. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, a configuration that indicates a plurality of beams; receive, from the UE, a multi-TRP request message, wherein the multi-TRP request message indicates multiple qualified beams from the plurality of beams; and perform, with the UE, a multi-TRP SDT based at least in part on the multiple qualified beams indicated by the multi-TRP request message. As described in more detail elsewhere herein, the communication manager 150 may transmit, to a UE, an RRC release message that indicates a TRP resource or beam configuration, wherein the TRP resource or beam configuration indicates multiple beams associated with multiple TRPs of the network node, respectively; and perform, with the UE, a multi-TRP SDT based at least in part on the TRP resource or beam configuration. Additionally, or alternatively, the communication manager 150 may perform one or more other operations described herein.

As indicated above, FIG. 1 is provided as an example. Other examples may differ from what is described with regard to FIG. 1.

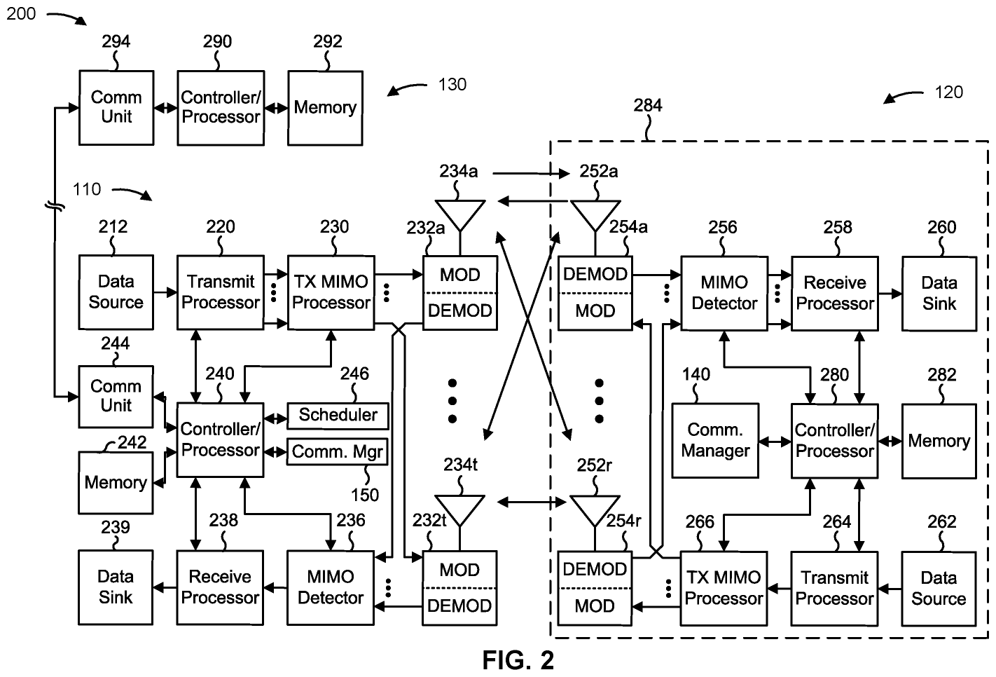

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

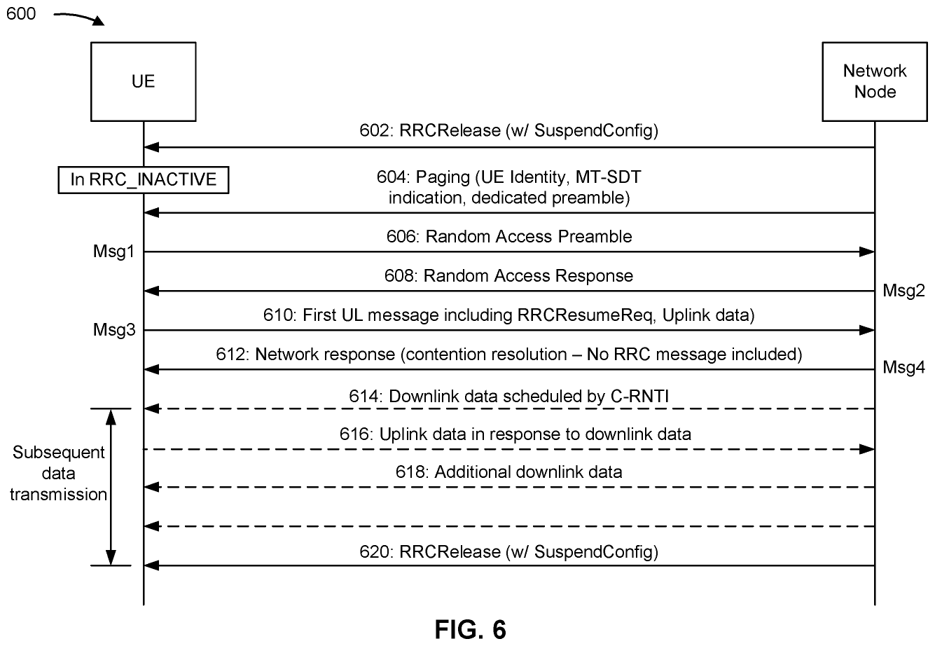

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-15).

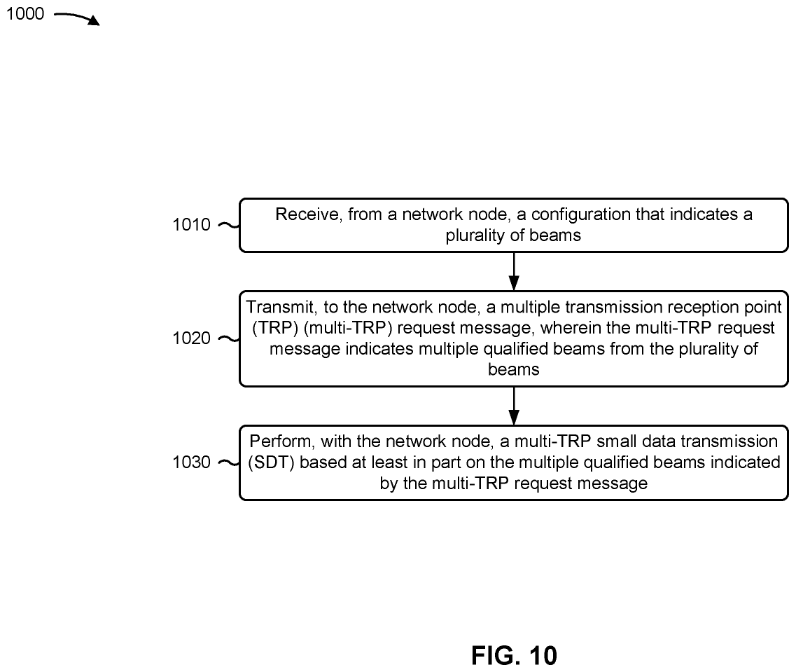

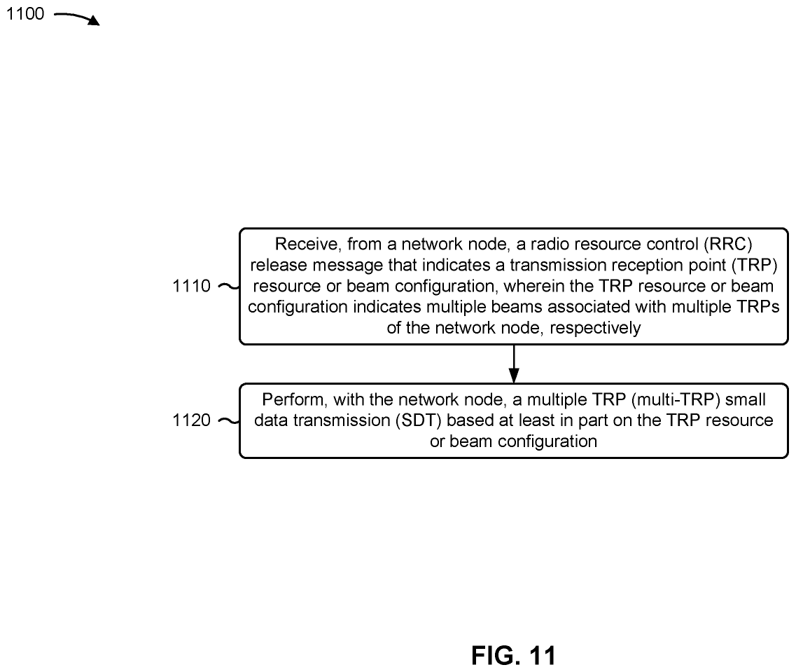

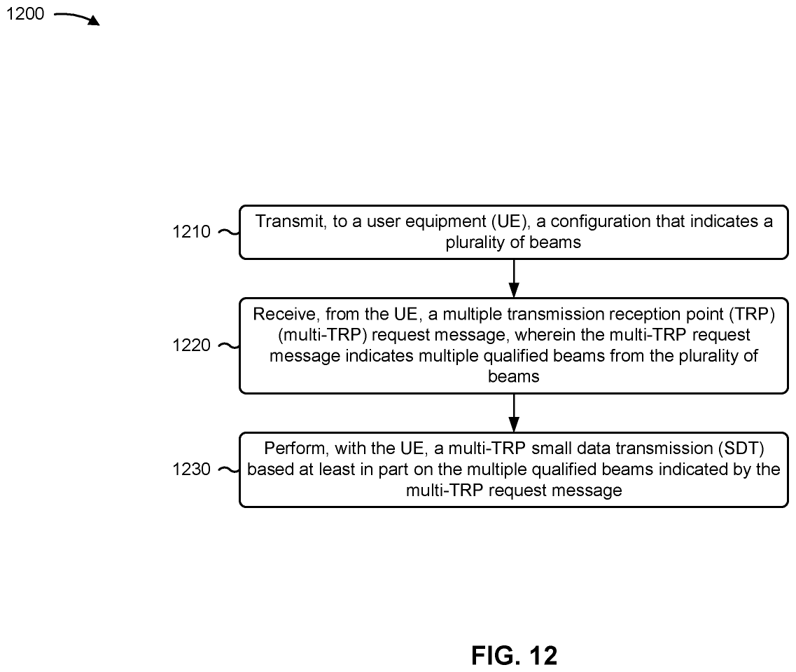

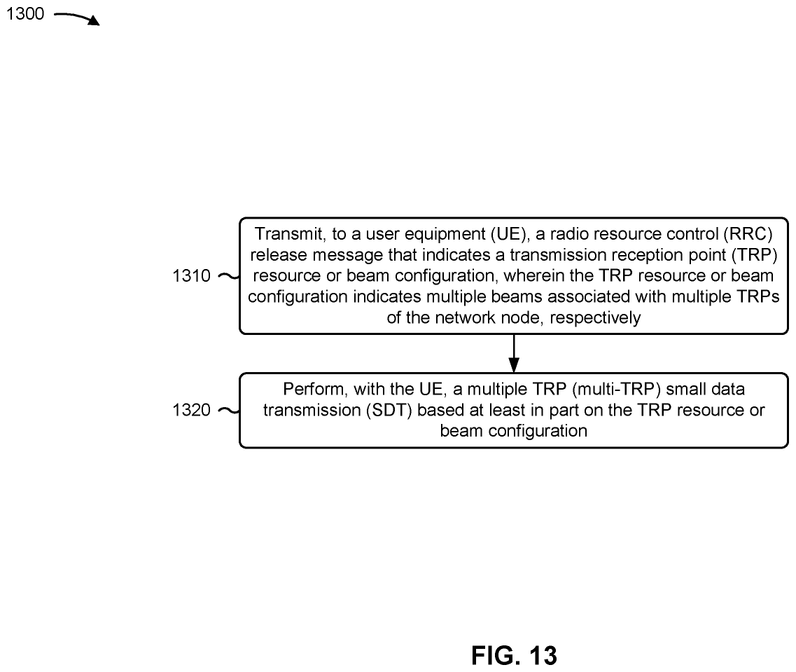

The controller/processor 240 of the network node 110, the controller/processor 280 of the UE 120, and/or any other component(s) of FIG. 2 may perform one or more techniques associated with SDTs for multiple TRPs, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network node, a configuration that indicates a plurality of beams; means for transmitting, to the network node, a multi-TRP request message, wherein the multi-TRP request message indicates multiple qualified beams from the plurality of beams; and/or means for performing, with the network node, a multi-TRP SDT based at least in part on the multiple qualified beams indicated by the multi-TRP request message. In some aspects, the UE (e.g., UE 120) includes means for receiving, from a network node, an RRC release message that indicates a TRP resource or beam configuration, wherein the TRP resource or beam configuration indicates multiple beams associated with multiple TRPs of the network node, respectively; and/or means for performing, with the network node, a multi-TRP SDT based at least in part on the TRP resource or beam configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting, to a UE, a configuration that indicates a plurality of beams; means for receiving, from the UE, a multi-TRP request message, wherein the multi-TRP request message indicates multiple qualified beams from the plurality of beams; and/or means for performing, with the UE, a multi-TRP SDT based at least in part on the multiple qualified beams indicated by the multi-TRP request message. In some aspects, the network node (e.g., network node 110) includes means for transmitting, to a UE, an RRC release message that indicates a TRP resource or beam configuration, wherein the TRP resource or beam configuration indicates multiple beams associated with multiple TRPs of the network node, respectively; and/or means for performing, with the UE, a multi-TRP SDT based at least in part on the TRP resource or beam configuration. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

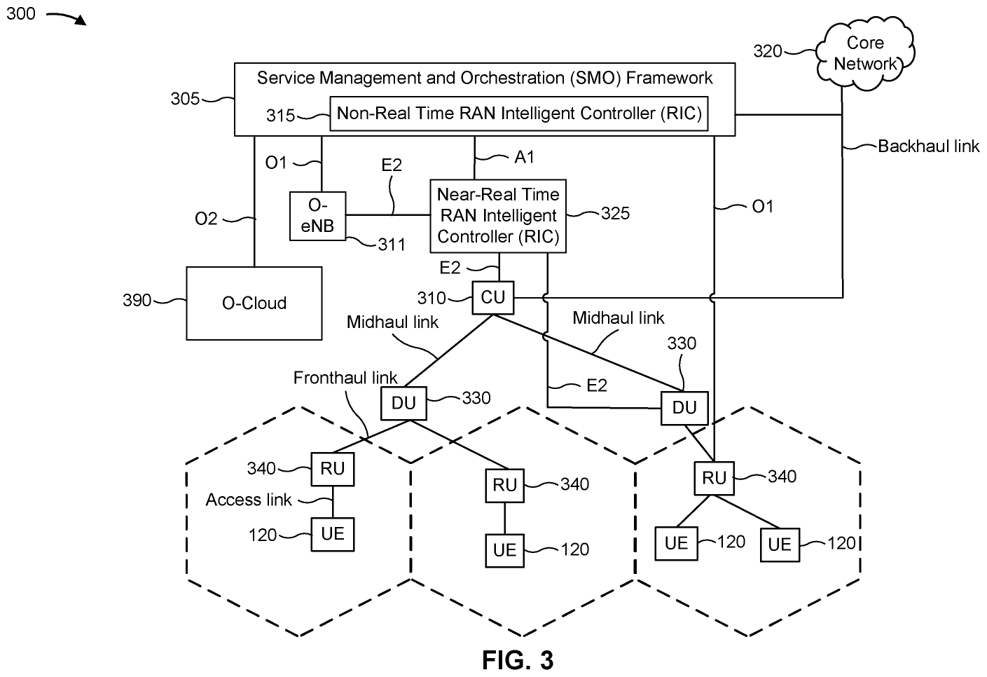

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O₂ interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

In a mobile originated (MO) SDT framework, a network node may allow a UE to transmit uplink small data in an RRC inactive/idle mode, without the UE having to move to an RRC connected mode. A random access channel (RACH) based SDT procedure may involve uplink SDTs for RACH-based schemes (e.g., two-step RACH or four-step RACH) from the RRC inactive state. A configured grant (CG) based SDT procedure may involve a transmission of uplink data on preconfigured physical uplink shared channel (PUSCH) resources (e.g., reusing a CG type 1). A subsequent transmission of small data in an uplink direction and in a downlink direction may be supported.

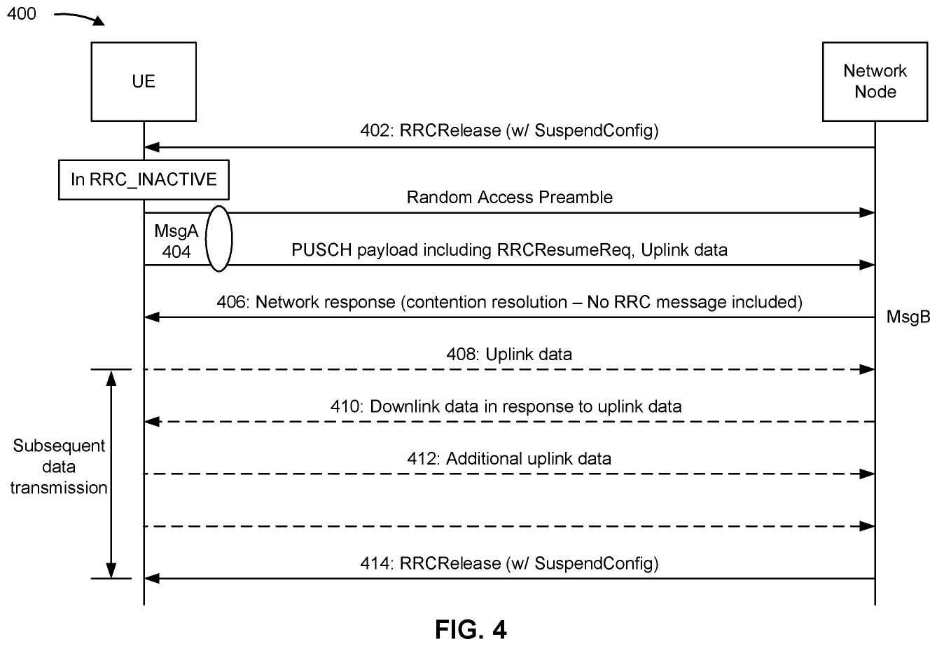

FIG. 4 is a diagram illustrating an example 400 of an MO-random access (RA)-SDT, in accordance with the present disclosure. As shown in FIG. 4, communication may occur between a UE (e.g., UE 120) and a network node (e.g., network node 110). In some aspects, the UE and the network node may be included in a wireless network, such as wireless network 100.

As shown by reference number 402, as part of MO-RA-SDT based at least in part on a two-step RACH, the UE may receive, from the network node, an RRC release message that indicates a suspend configuration, and the UE may enter an RRC inactive/idle mode. As shown by reference number 404, the UE may transmit, to the network node, a random access preamble and a PUSCH payload including an RRC resume request and uplink data, which may be part of a MsgA. As shown by reference number 406, the UE may receive, from the network node, a network response that indicates a contention resolution, which may be part of a MsgB, where the network response may not include an RRC message. At this point, subsequent data transmissions may occur between the UE and the network node. As shown by reference number 408, the UE may transmit uplink data to the network node. As shown by reference number 410, the UE may receive, from the network node, downlink data in response to the uplink data. As shown by reference number 412, the UE may transmit additional uplink data to the network node. As shown by reference number 414, the UE may receive, from the network node, an RRC release message that indicates a suspend configuration.

As indicated above, FIG. 4 is provided as an example. Other examples may differ from what is described with regard to FIG. 4.

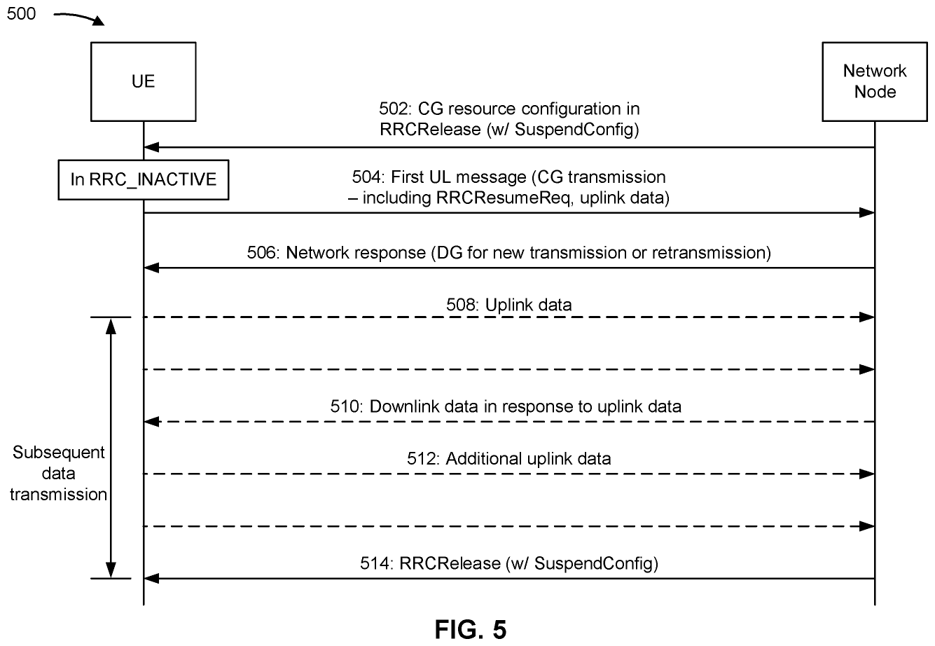

FIG. 5 is a diagram illustrating an example 500 of an MO-CG-SDT, in accordance with the present disclosure. As shown in FIG. 5, communication may occur between a UE (e.g., UE 120) and a network node (e.g., network node 110). In some aspects, the UE and the network node may be included in a wireless network, such as wireless network 100.

As shown by reference number 502, as part of the MO-CG-SDT, the UE may receive, from the network node, a CG resource configuration in an RRC release message which indicates a suspend configuration, and the UE may enter an RRC inactive/idle mode. As shown by reference number 504, the UE may transmit, to the network node, a first uplink message, which may be a CG transmission that indicates an RRC resume request and uplink data. As shown by reference number 506, the UE may receive, from the network node, a network response, which may indicate a dynamic grant (DG) for a new transmission or a retransmission. At this point, subsequent data transmissions may occur between the UE and the network node. As shown by reference number 508, the UE may transmit uplink data to the network node. As shown by reference number 510, the UE may receive, from the network node, downlink data in response to the uplink data. As shown by reference number 512, the UE may transmit additional uplink data to the network node. As shown by reference number 514, the UE may receive, from the network node, an RRC release message that indicates a suspend configuration.

As indicated above, FIG. 5 is provided as an example. Other examples may differ from what is described with regard to FIG. 5.

A mobile terminated (MT) SDT may be a downlink data initiated SDT. An MT SDT may support a paging triggered SDT. MT SDTs may involve initial downlink data receptions and subsequent uplink/downlink data transmissions in an RRC inactive/idle mode of a UE. An MO-RA-SDT procedure and an MO-CG-SDT procedure may be reused as an uplink response.

FIG. 6 is a diagram illustrating an example 600 of an MT-RA-SDT, in accordance with the present disclosure. As shown in FIG. 6, communication may occur between a UE (e.g., UE 120) and a network node (e.g., network node 110). In some aspects, the UE and the network node may be included in a wireless network, such as wireless network 100.

As shown by reference number 602, as part of an MT-RA-SDT based at least in part on a four-step RACH, the UE may receive, from the network node, an RRC release message that indicates a suspend configuration, and the UE may enter an RRC inactive/idle mode. As shown by reference number 604, the UE may receive, from the network node, a paging message, which may include a UE identity, an MT-SDT indication, and a dedicated preamble. As shown by reference number 606, the UE may transmit, to the network node, a random access preamble (Msg1). As shown by reference number 608, the UE may receive, from the network node, a random access response (Msg2). As shown by reference number 610, the UE may transmit, to the network node, a first uplink message that indicates an RRC resume request and uplink data (Msg3). As shown by reference number 612, the UE may receive, from the network node, a network response that indicates a contention resolution (Msg4), where the network response may not include an RRC message. As shown by reference number 614, the UE may receive, from the network node, downlink data scheduled by a cell radio network temporary identifier (C-RNTI). At this point, subsequent data transmissions may occur between the UE and the network node. As shown by reference number 616, the UE may transmit, to the network node, uplink data in response to the downlink data scheduled by the C-RNTI. As shown by reference number 618, the UE may receive, from the network node, additional downlink data. As shown by reference number 620, the UE may receive, from the network node, an RRC release message that indicates a suspend configuration.

As indicated above, FIG. 6 is provided as an example. Other examples may differ from what is described with regard to FIG. 6.

For MO-SDTs, CG-SDT resources may be configured via RRC signaling. An association between CG-SDT resources and synchronization signal blocks (SSBs) may be configured for CG-SDTs. An X-to-1 mapping between SSBs and CG PUSCHs (or CG-SDT resources) may be specified. An exact mapping ratio may be explicitly signaled via RRC signaling. A CG-SDT may only support a single antenna port and a single-layer transmission, and a sounding reference signal (SRS) resource indicator (SRI) may not be applicable to the CG-SDT. A CG-SDT resource selection may be based at least in part on an SSB evaluation. At a CG-SDT initiation stage, when an RSRP of at least one SSB configured for CG-SDT satisfies a threshold, a CG-SDT procedure may be performed. During a subsequent new CG-SDT transmission phase, a UE may re-evaluate the SSB for a subsequent CG-SDT. Given a mapping between the SSBs and the CG-SDT resources, CG-SDT resources for small data may be associated with selected SSBs.

In a multiple TRP (multi-TRP or mTRP) operation, a serving cell may schedule the UE from two TRPs, which may provide improved coverage, reliability and/or data rates for a physical downlink shared channel (PDSCH), a physical downlink control channel (PDCCH), a PUSCH, and a physical uplink control channel (PUCCH). Two different operation modes may be available for scheduling multi-TRP PDSCH transmissions, which may be a single downlink control information (DCI) operation mode or a multi-DCI operation mode. In the single-DCI operation mode, the UE may be scheduled by the same DCI for both TRPs. In the multi-DCI operation mode, the UE may be scheduled by independent DCIs from each TRP. For a PDSCH repetition, in a single-DCI multi-TRP configuration, the UE may receive a PDSCH transmission in spatial division multiplexing (SDM), frequency division multiplexing (FDM), and/or time division multiplexing (TDM) manners for robustness. For a PDCCH repetition, the UE may receive two PDCCH transmissions, one from each TRP, carrying the same DCI. For a multi-TRP PDSCH repetition, based at least in part on an indication in a DCI or a CG provided via RRC signaling, the UE may perform two PUSCH transmissions with the same content to two TRPs with corresponding beam directions associated with different spatial relations. For a multi-TRP PUCCH repetition, the UE may perform two PUCCH transmissions with the same content to two TRPs with corresponding beam directions associated with different spatial relations.

A multi-TRP repetition may be enabled for MO-SDTs or MT-SDTs, which may improve a reliability of small data transmission and/or reception. The multi-TRP repetition may be beneficial for IoT devices when performing SDT in poor coverage areas, as well as for industrial IoT use cases.

However, past solutions are insufficient for enabling multi-TRP operations for SDTs. For example, past solutions do not define mechanisms for enabling two beams or transmission configuration indication (TCI) states for multi-TRP operation during SDT. Past solutions do not consider a beam management configuration (e.g., with or without the beam management configuration) for an inactive state case. When beam management is configured, a network node may directly indicate two beams of two TRPs for a multi-TRP repetition and update beams using a TCI state medium access control control element (MAC-CE). Otherwise, a UE assisted multi-TRP enabled scheme may be used. Further, past solutions do not define mechanisms for indicating qualified candidate beams to the network node when the UE requests to enable multi-TRP repetitions.

In various aspects of techniques and apparatuses described herein, a UE may receive, from a network node, a configuration that indicates a plurality of beams. The UE may transmit, to the network node, a multi-TRP request message (or multi-TRP assistance message), where the multi-TRP request message may indicate multiple qualified beams from the plurality of beams. The multi-TRP request message may request the network node to activate, deactivate, configure, reconfigure, and/or update a multi-TRP operation for SDT. In some aspects, the UE may transmit the multi-TRP request message based at least in part on a quantity of failed downlink transmissions satisfying a threshold. In some aspects, the UE may evaluate a plurality of SSBs associated with the plurality of beams, respectively, and the multi-TRP request message may indicate qualified candidate SSB indices associated with the multiple qualified beams. The multi-TRP request message may indicate a UE preference on whether to activate or deactivate the multi-TRP SDT operation. The multi-TRP operation may be applicable for all types of SDT, which may include RA-SDT, CG-SDT, MO-SDT, and/or MT-SDT.

In some aspects, the UE may transmit the multi-TRP request message based at least in part on a best beam, of the plurality of beams, not satisfying a threshold. The UE may evaluate a plurality of configured beams. Even when a best beam, of the plurality of beams, does not satisfy the threshold, the UE may request a multi-TRP SDT repetition to improve a small data reliability. The best beam may be associated with a higher measurement (e.g., a higher RSRP measurement) as compared to other beams of the plurality of beams.

As described herein, an “SDT” may be infrequent and small data, which may be transmitted by the UE in an RRC inactive/idle state without the UE needing an RRC state transition (e.g., a transition to an RRC connected state). An “SDT” may be defined by the 3GPP standard. An “SDT” may be data that is transmitted in the RRC inactive/idle state and/or for IoT devices. When a size of data to be transmitted satisfies a threshold (e.g., exceeds the threshold), the data may not qualify as an SDT, and may require an RRC state transition in order to be transmitted.

In some aspects, the UE may perform, with the network node, a multi-TRP SDT based at least in part on the multiple qualified beams indicated by the multi-TRP request message. For example, the UE may transmit, to the network node, the multi-TRP SDT based at least in part on the multiple qualified beams indicated by the multi-TRP request message, or the UE may receive, from the network node, the multi-TRP SDT based at least in part on the multiple qualified beams indicated by the multi-TRP request message. In some aspects, the UE may be configured with a first beam for communication with a first TRP of multiple TRPs, where a selected beam from the multiple qualified beams may be a second beam for communication with a second TRP of the multiple TRPs, and the first beam and the second beam may enable two TCI states for a multi-TRP SDT operation.

In some aspects, the UE may perform the multi-TRP SDT based at least in part on a UE capability of supporting multi-TRP SDTs in one or more physical channels, reported measurements of downlink reference signaling (e.g., SSBs, tracking reference signals (TRSs), or channel state information reference signals (CSI-RSs)) associated with the plurality of beams not satisfying a first threshold, a quantity of failed uplink transmissions satisfying a second threshold, and/or the multi-TRP request message indicating the multiple qualified beams and an activation or deactivation request. In some aspects, the multi-TRP SDT may be associated with a multi-TRP repetition for SDT, where the multi-TRP SDT may be based at least in part on transmitting a same or repeated uplink data or signaling towards two TRPs, or the multi-TRP SDT may be based at least in part on receiving a same or repeated downlink data or signaling from the two TRPs, which may improve a reliability of SDTs. In some aspects, the UE may perform the multi-TRP SDT based at least in part on a TDM, an FDM, or an SDM depending on whether the multiple qualified beams are reported in separate groups.

In some aspects, the UE may receive, from the network node, an RRC release message that indicates a TRP resource or beam configuration, where the TRP resource or beam configuration may indicate multiple beams associated with multiple TRPs of the network node, respectively. The UE may perform, with the network node, a multi-TRP SDT based at least in part on the TRP resource or beam configuration. For example, the UE may transmit, to the network node, the multi-TRP SDT based at least in part on the multiple beams indicated by the TRP resource or beam configuration, or the UE may receive, from the network node, the multi-TRP SDT based at least in part on the multiple beams indicated by the TRP resource or beam configuration. In some aspects, the TRP resource or beam configuration may configure a set of more than two beams when the UE moves to an RRC inactive/idle state, and the UE may select two qualified beams (e.g., best/qualified beams), among the set of more than two beams, for the multi-TRP SDT. In some aspects, the UE may perform the multi-TRP SDT based at least in part on multiple corresponding CG occasions associated with the multiple beams indicated by the TRP resource or beam configuration, or the UE may fall back to select one corresponding CG occasion for SDT without a multi-TRP repetition based at least in part on the network node indicating only one beam.

In some aspects, the UE may enter an RRC inactive/idle state based at least in part on receiving the RRC release message, where the UE may receive the RRC release message while operating in an RRC connected state. Two beams corresponding to two TRPs may already be configured when the UE is in the RRC connected state or may be configured in the RRC release message for the UE to use when performing the multi-TRP SDT in the RRC inactive state.

In some aspects, a network node may directly enable multi-TRP operations for SDTs. When a UE is in a connected state, the network node may configure two beams (e.g., for two TRPs) in an RRC release message. When uplink or downlink small data arrives at the UE (e.g., for an MO-SDT or an MT-SDT), the UE may use the configured two beams to perform a multi-TRP PUSCH repetition upon an MT-SDT initiation. A beam management configuration may be configured for an RRC inactive UE. The network node may use a TCI state activation MAC-CE to update activated beams for a multi-TRP repetition during an SDT. For an uplink CG-PUSCH transmission, the UE may select two corresponding CG occasions associated with two indicated beams to transmit the same uplink small data. When two CG-PUSCH transmissions both fail, the network node may update two beams via the TCI state activation MAC-CE. When the network node indicates only one beam using the TCI state activation MAC-CE, the UE may fall back to select one corresponding CG occasion for an SDT (or small data transfer) without a multi-TRP repetition.

In some aspects, the network node may configure a set of beams (e.g., more than two beams) when the UE moves to an RRC-inactive state, and the UE may select two beams (e.g., best/qualified beams) among the configured set of beams for a multi-TRP repetition, or the UE may select CG occasions. The UE may select two corresponding CG occasions associated to the selected beams for uplink SDT, and the UE may expect to receive a multi-TRP repetition PDCCH/PDSCH with the selected beam. In some aspects, two beams may be configured in an RRC release message for an RA-SDT. A Msg1/Msg3 may be repeated with different beams, and a multi-TRP repetition PDCCH/PDSCH may be enabled in or after a Msg4/MsgB. In some cases, the configured beams in the RRC release message may be already outdated when a small data traffic arrives.

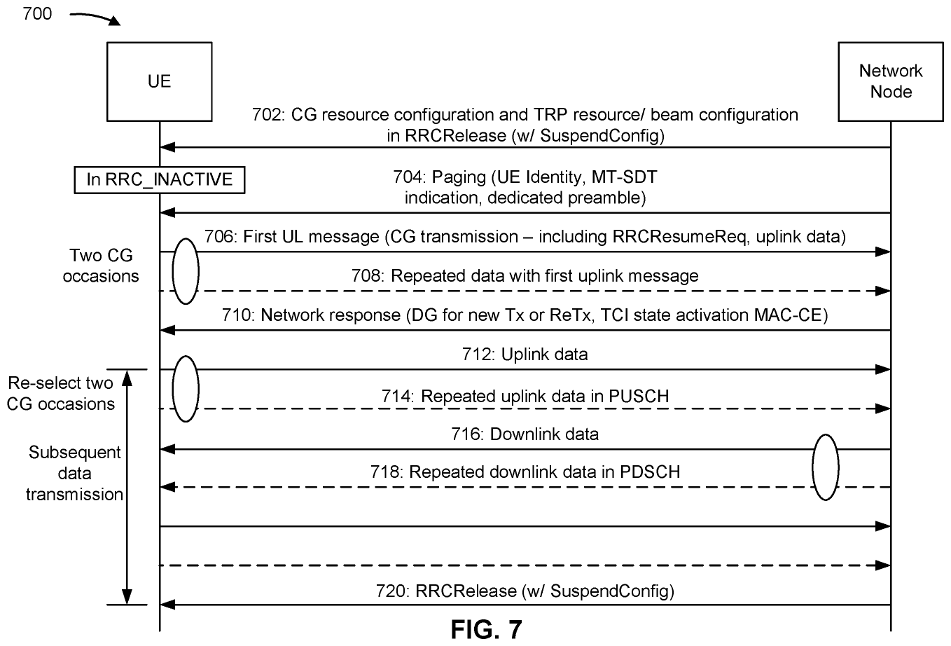

FIG. 7 is a diagram illustrating an example 700 associated with SDTs for multiple TRPs, in accordance with the present disclosure. As shown in FIG. 7, communication may occur between a UE (e.g., UE 120) and a network node (e.g., network node 110). In some aspects, the UE and the network node may be included in a wireless network, such as wireless network 100.

As shown by reference number 702, the UE may receive, from the network node, a CG resource configuration and a TRP resource/beam configuration in an RRC release message with a suspend configuration, where the TRP resource/beam configuration may configure two beams for two TRPs. The UE may receive the TRP resource/beam configuration when operating in a connected state. At a later time, the UE may enter an RRC inactive state. As shown by reference number 704, the UE may receive, from the network node, a paging message, which may include a UE identity, an MT-SDT indication, and a dedicated preamble. As shown by reference number 706, the UE may transmit, to the network node, a first uplink message, which may be a CG transmission that indicates an RRC resume request and uplink data. As shown by reference number 708, the UE may transmit, to the network node, repeated data with the first uplink message. The first uplink message and the repeated data with the first uplink message may be based at least in part on two CG occasions. As shown by reference number 710, the UE may receive, from the network node, a network response, which may indicate a DG for a new transmission or a retransmission. The network response may also indicate a TCI state activation MAC-CE, which may be used by the network node to update activated beams for a multi-TRP repetition during an SDT.

In some aspects, at this point, subsequent data transmissions may occur between the UE and the network node. As shown by reference number 712, the UE may transmit uplink data to the network node. As shown by reference number 714, the UE may transmit, to the network node, repeated uplink data in a PUSCH. The UE may reselect two CG occasions for transmitting the uplink data and the repeated uplink data in the PUSCH. In other words, for uplink CG-PUSCH transmissions, the UE may select two corresponding CG occasions associated with two indicated beams to transmit the same uplink small data. As shown by reference number 716, the UE may receive downlink data from the network node. As shown by reference number 718, the UE may receive, from the network node, repeated downlink data in a PDSCH. As shown by reference number 720, the UE may receive, from the network node, an RRC release message that indicates a suspend configuration.

As indicated above, FIG. 7 is provided as an example. Other examples may differ from what is described with regard to FIG. 7.

In some aspects, a UE-assisted multi-TRP operation may be enabled for SDTs. A network node may preconfigure a set of beams via RRC signaling for an RRC inactive UE. The UE may indicate, to the network node, a set of qualified candidate beams when the UE enables a multi-TRP repetition during an SDT. The UE may evaluate an SSB to select a CG occasion or an RA occasion at an SDT initiation phase. The UE may additionally evaluate other SSBs in a configured list and report, to the network node, qualified candidate SSB indicates. The network node may preconfigure a set of SSBs associated with CG occasions or RA occasions. The network node may configure an RSRP threshold of an SSB for detecting a qualified candidate beam.

In some aspects, the UE may receive, from the network node and when operating in an RRC inactive/idle state, a TRS configuration that indicates one or more TRS resources, where multiple qualified beams may be determined based at least in part on one or more TRSs associated with the one or more TRS resources. SSB resources may be configured for the UE for MT-SDTs, and TRS resources may be configured for the UE to monitor a TCI state indication of a PDCCH/PDSCH. A shared TRS configuration may be advertised in system information. When the network node releases the UE into an RRC inactive state, the network node may provide the UE with the same TRS configuration as in the system information. The UE may evaluate a TRS to determine whether a qualified candidate beam is available. When group based beam reporting is enabled, the UE may separate qualified candidate beams in different groups, where the group based beam reporting may be configured in a channel state information (CSI) report configuration. The group based beam reporting (e.g., a groupBasedBeamReporting parameter) may be enabled or configured via RRC signaling.

In some aspects, a condition for triggering the UE to transmit an indication to the network node for enabling a multi-TRP repetition for an SDT may be based at least in part on a best beam still being below a configured threshold, or when a quantity of failed downlink transmissions (in an MT-SDT) reaches a configured threshold in a timer/window. An indication of qualified beams may be encapsulated in a new message or signaling, such as a multi-TRP request message. The new message or signaling may be RRC signaling, a MAC-CE, an information element (IE) in UE assistance information (UAI), or uplink control information (UCI). In some aspects, the UE may transmit, to the network node, the multi-TRP request message in a first uplink message along with a common control channel (CCCH) and user data, or in any uplink transmission in a subsequent data phase. Further, the multi-TRP request message may be carried in a CG-PUSCH in a CG-SDT, or in a MsgA/Msg3 in an RA-SDT.

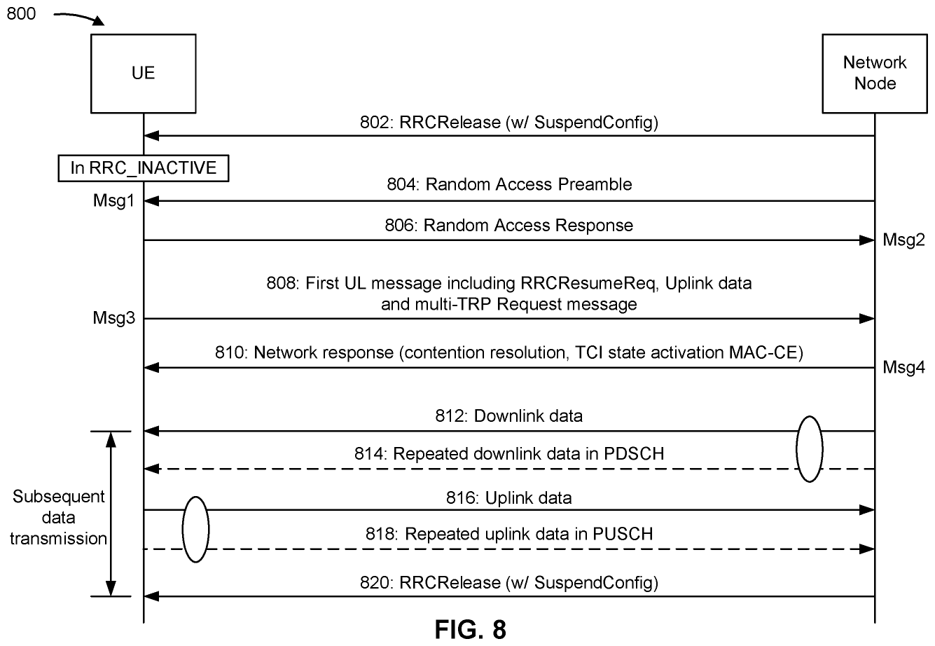

FIG. 8 is a diagram illustrating an example 800 associated with SDTs for multiple TRPs, in accordance with the present disclosure. As shown in FIG. 8, communication may occur between a UE (e.g., UE 120) and a network node (e.g., network node 110). In some aspects, the UE and the network node may be included in a wireless network, such as wireless network 100.

As shown by reference number 802, the UE may receive, from the network node, an RRC release message with a suspend configuration, and the UE may enter an RRC inactive state. As shown by reference number 804, the UE may transmit, to the network node, a random access preamble (Msg1). As shown by reference number 806, the UE may receive, from the network node, a random access response (Msg2). As shown by reference number 808, the UE may transmit, to the network node, a first uplink message that includes an RRC resume request, uplink data, and a multi-TRP request message (Msg3). The multi-TRP request message may indicate qualified beams, which may enable a multi-TRP repetition for an SDT. The UE may transmit the multi-TRP request message based at least in part on a best beam still being below a configured threshold, or when a quantity of failed downlink transmissions (in an MT-SDT) reaches a configured threshold in a timer/window. As shown by reference number 810, the UE may receive, from the network node, a network response that indicates a contention resolution and a TCI state activation MAC-CE (Msg4). At this point, subsequent data transmissions may occur between the UE and the network node. As shown by reference number 812, the UE may receive downlink data from the network node. As shown by reference number 814, the UE may receive, from the network node, repeated downlink data in a PDSCH. As shown by reference number 816, the UE may transmit uplink data to the network node. As shown by reference number 818, the UE may transmit, to the network node, repeated uplink data in a PUSCH. As shown by reference number 820, the UE may receive, from the network node, an RRC release message that indicates a suspend configuration.

As indicated above, FIG. 8 is provided as an example. Other examples may differ from what is described with regard to FIG. 8.

In some aspects, a UE-assisted multi-TRP operation may be enabled for SDTs. When a network node receives, from a UE, a multi-TRP request message including a set of qualified candidate beams (in addition to those used for a CG occasion or an RA occasion), the network node may determine whether to enable a multi-TRP operation in an SDT. The network node may enable a multi-TRP repetition for one or more PHY channels (e.g., PDCCH, PDSCH, PUCCH, and/or PUSCH) when a criterion is satisfied. For example, the network node may enable the multi-TRP repetition based at least in part on a UE capability, which may indicate whether the UE supports a multi-TRP repetition for an SDT in one or more PHY channels. The network node may enable the multi-TRP repetition based at least in part on reported layer 1 (L1) RSRP measurements of SSBs being below a configured threshold, where the reported L1 RSRP measurements of the SSB may be associated with the used CG occasion or the RA occasion. The network node may enable the multi-TRP repetition based at least in part on a quantity of failed uplink transmissions reaching a configured threshold, where the failed uplink transmissions may be associated with a DG for a retransmission grant. The network node may enable the multi-TRP repetition based at least in part on the multi-TRP request message including the set of qualified candidate beams and an activation/deactivation request.

In some aspects, when the UE reports the set of qualified candidate beams in separate groups based at least in part on a configuration of a group based beam reporting, the network node may configure an SDM based multi-TRP PDSCH repetition. Otherwise, when the set of qualified candidate beams are not separated into two groups, a TDM or FDM based multi-TRP PDSCH repetition may be enabled. Further, only beams which are separated into the two groups may be simultaneously transmitted to the UE.

In some aspects, when the network node determines to enable a second beam for a multi-TRP repetition, the network node may indicate, to the UE, the second beam for the multi-TRP repetition using DCI. For example, the network node may transmit DCI, to indicate the second beam, in a DG for a retransmission or in a DG for a new transmission. In some aspects, when the network node determines to enable a second beam for a multi-TRP repetition, the network node may enable the second beams by reusing a TCI state activation MAC-CE. When the network node uses a legacy TCI activation MAC-CE, the one beam that is currently being used may be restricted. In some aspects, the UE may receive, from the network node, DCI or a TCI state activation MAC-CE, where the DCI or the TCI state activation MAC-CE may indicate a first beam that corresponds to a beam currently being used by the UE, and a second beam that corresponds to a new beam to be used for the multi-TRP SDT.

In some aspects, the network node may disable the multi-TRP repetition during the SDT. When disabling the multi-TRP repetition during the SDT, the network node may indicate, to the UE, a certain beam using DCI or a TCI state activation MAC-CE, where the beam may be a first beam or the second beam. The network node may select which beam (e.g., the first beam or the second beam) is to be used when multi-TRP repetition is not needed, and a corresponding CG resource associated with this beam may be selected accordingly.

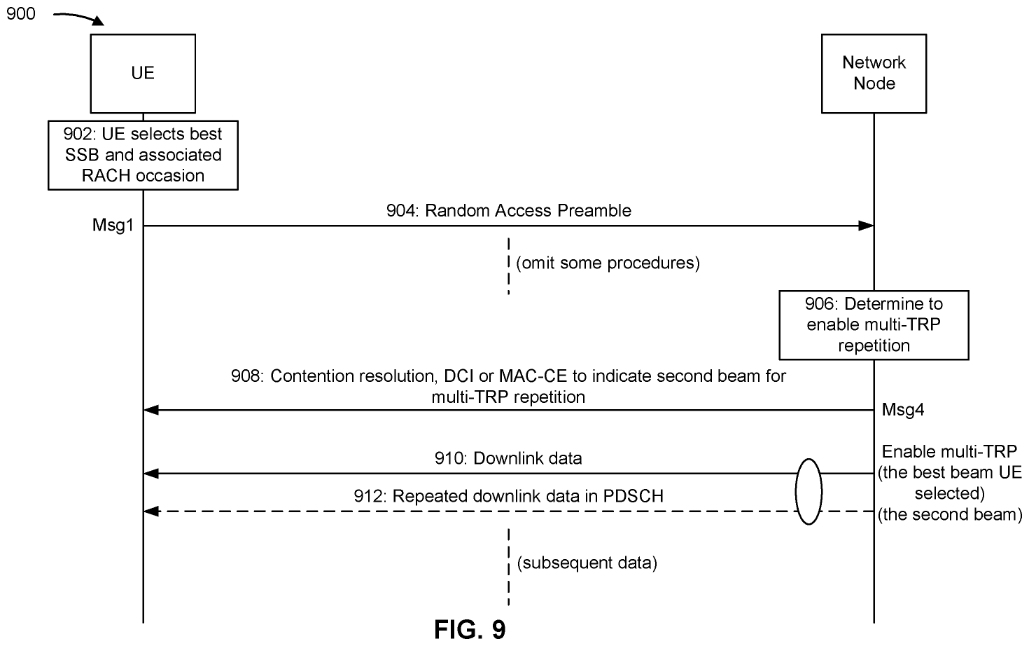

FIG. 9 is a diagram illustrating an example 900 associated with SDTs for multiple TRPs, in accordance with the present disclosure. As shown in FIG. 9, communication may occur between a UE (e.g., UE 120) and a network node (e.g., network node 110). In some aspects, the UE and the network node may be included in a wireless network, such as wireless network 100.

As shown by reference number 902, the UE may select a best SSB and an associated RACH occasion, which the best SSB may be mapped to the RACH occasion. As shown by reference number 904, the UE may transmit, to the network node, a random access preamble (Msg1). The UE may receive a random access response (Msg3), and transmit a multi-TRP request message (Msg3) (as shown in FIG. 8). As shown by reference number 906, the network node, after receiving the multi-TRP request message that indicates a set of qualified candidate beams, the network node may determine whether to enable a multi-TRP operation in an SDT. The network node may determine to enable a multi-TRP repetition based at least in part on a UE capability, reported L1 RSRP measurements of SIBs satisfying a threshold (e.g., being below a configured threshold), a quantity of failed uplink transmissions satisfying a threshold (e.g., reaching a configured threshold), and/or the multi-TRP request message indicating the set of qualified candidate beams and an activation/deactivation request. As shown by reference number 908, the network node may transmit a network response (Msg4) to the UE. The network response may indicate a contention resolution. The network response may include DCI or a MAC-CE (e.g., a TCI state activation MAC-CE) to indicate a second beam for enabling the multi-TRP repetition. In other words, the network response may indicate, to the UE, the DCI or the MAC-CE for enabling the multi-TRP repetition. As shown by reference number 910, the UE may receive, from the network node, downlink data based at least in part on a first beam (e.g., a best beam that is UE-selected). As shown by reference number 912, the UE may receive, from the network node, repeated downlink data using the second beam, where the network node may have previously enabled the second beam for the multi-TRP repetition.

As indicated above, FIG. 9 is provided as an example. Other examples may differ from what is described with regard to FIG. 9.

In some aspects, when a network node configures a multi-TRP resource for a UE, the UE may transmit or receive small data in a multi-TRP repetition manner during an RA-SDT. For a downlink data multi-TRP repetition, after a Msg4/MsgB contention resolution, the network node may indicate a second beam via DCI or a MAC-CE to enable two TCI states for a PDCCH/PDSCH (e.g., to enable a second TCI state). The UE may expect to receive a repeated PDCCH and/or a downlink small data repetition in a PDSCH in a subsequent SDT phase. For an uplink data multi-TRP repetition, a new multi-TRP request message may be transmitted in a Msg3/MsgA to request the network node to enable a multi-TRP repetition mode after a Msg4/MsgB. After receiving the multi-TRP request message, the network node may indicate the second beam to enable a PUCCH repetition. The uplink data multi-TRP repetition may be a first uplink message, which may include an RRC resume request message when the multi-TRP repetition is preconfigured by the network node. The uplink data multi-TRP repetition may be uplink small data in an MO-SDT subsequent phase or an MT-SDT subsequent phase when the network node configures and activates the multi-TRP repetition after the Msg4/MsgA.

In some aspects, a CG-SDT procedure may be configured with the multi-TRP repetition. After the network node successfully receives the first uplink message including the RRC resume request in an MO-SDT or an MT-SDT, and after the network node successfully receives the multi-TRP request message, the network node may indicate the second beam to enable the two TCI states for the PDCCH/PDSCH (e.g., to enable a second TCI state). After the second beam is indicated to the UE, via either DCI or a MAC-CE, the UE may expect to receive the repeated PDCCH or the downlink small data repetition in the PDSCH in the subsequent SDT phase. When the network node configures a multi-TRP PUSCH repetition resource, which may be associated with one set of SSB or two sets of SSBs, the UE may transmit the same uplink small data in a CG-PUSCH multi-TRP repetition resource.

In some aspects, a multi-TRP resource for an SDT may be configured via dedicated RRC signaling (e.g., an RRC release message), or an RRC reconfiguration message for an MO-SDT or an MT-SDT. The UE may receive, from the network node, a configuration of the multi-TRP resources via dedicated signaling or broadcast signaling. In a first example, the UE may receive, from the network node, the RRC release message, and the UE may move from an RRC connected state to an RRC inactive state. In a second example, the RRC release message may be transmitted at an end to terminate an SDT procedure, and the UE may use a configured multi-TRP resource along with an updated CG resource in a next SDT session. In a third example, the UE may receive the RRC reconfiguration including the multi-TRP resource during an SDT, and the UE may apply the multi-TRP repetition for small data in a subsequent SDT.

In some aspects, in an MO-SDT design, since an SRI is not applicable for a CG resource configured for SDT, a multi-TRP PUSCH repetition for a CG (e.g., which requires a configuration of two SRS resource sets) may to be workable. In some aspects, for a CG PUSCH multi-TRP repetition configuration, in a given CG-SDT configuration, one set of SSB may be configured to associate with one set of CG occasion. One restriction may be that one SSB may be configured to associate with two CG occasions, where the two CG occasions may be time division multiplexed or frequency division multiplexed. The UE may transmit the same uplink data in the two CG occasions based at least in part on a selected qualified SSB among the one set of SSB (e.g., the SSB set). In some aspects, for the CG PUSCH multi-TRP repetition configuration, in the given CG-SDT configuration, two sets of SSBs may be configured, which may map to two corresponding sets of CG occasions. The UE may transmit the same uplink data in the two CG occasions selected from the two sets of CG occasions based at least in part on SSB measurements from the two sets of SSBs. In some cases, group based beam reporting may be configured to separate the SSBs into two groups. The UE may receive, from the network node, a CG SDT configuration that indicates a set of SSBs that are associated with one set of CG occasions, where one SSB may be configured to be associated with two CG occasions, or two sets of SSBs that are associated with two sets of CG occasions. In some aspects, for an RRC configuration, a second PO value (e.g., sdt-PO-PUSCH-r17) and a second alpha value (e.g., sdt-Alpha-r17) may need to be configured based at least in part on a configuration of a CG PUSCH for a multi-TRP repetition.

In some aspects, a UE capability may support a multi-TRP operation in an SDT. The UE may report, to the network node, an optional capability as to whether the UE supports multi-TRP operations for SDT in an RRC inactive/idle mode. The UE may transmit, to the network node, capability signaling which may indicate different multi-TRP repetition schemes used for SDT, such as TDM/FDM/SDM repetition schemes, and/or separate capabilities of a PDCCH, PDSCH, PUCCH, and/or PUSCH multi-TRP repetition for SDT.

FIG. 10 is a diagram illustrating an example process 1000 performed, for example, by a UE, in accordance with the present disclosure. Example process 1000 is an example where the UE (e.g., UE 120) performs operations associated with SDTs for multiple TRPs.

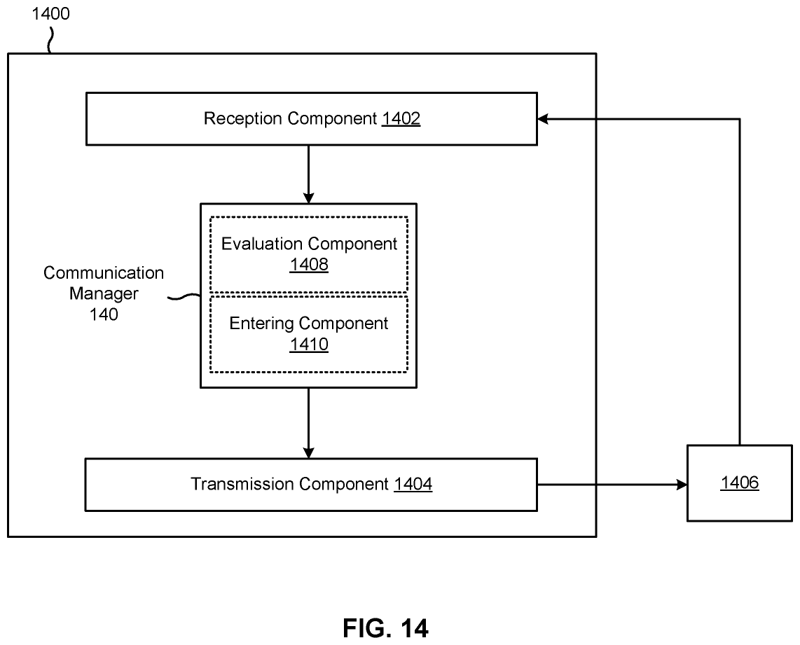

As shown in FIG. 10, in some aspects, process 1000 may include receiving, from a network node, a configuration that indicates a plurality of beams (block 1010). For example, the UE (e.g., using communication manager 140 and/or reception component 1402, depicted in FIG. 14) may receive, from a network node, a configuration that indicates a plurality of beams, as described above.

As further shown in FIG. 10, in some aspects, process 1000 may include transmitting, to the network node, a multi-TRP request message, wherein the multi-TRP request message indicates multiple qualified beams from the plurality of beams (block 1020). For example, the UE (e.g., using communication manager 140 and/or transmission component 1404, depicted in FIG. 14) may transmit, to the network node, a multi-TRP request message, wherein the multi-TRP request message indicates multiple qualified beams from the plurality of beams, as described above.

As further shown in FIG. 10, in some aspects, process 1000 may include performing, with the network node, a multi-TRP SDT based at least in part on the multiple qualified beams indicated by the multi-TRP request message (block 1030). For example, the UE (e.g., using communication manager 140, and/or reception component 1402 and/or transmission component 1404, depicted in FIG. 14) may perform, with the network node, a multi-TRP SDT based at least in part on the multiple qualified beams indicated by the multi-TRP request message, as described above.

Process 1000 may include additional aspects, such as any single aspect or any combination of aspects described below and/or in connection with one or more other processes described elsewhere herein.

In a first aspect, the UE is configured with a first beam for communication with a first TRP of multiple TRPs, wherein a selected beam from the multiple qualified beams is a second beam for communication with a second TRP of the multiple TRPs, and the first beam and the second beam enable two TCI states for a multi-TRP SDT operation.

In a second aspect, alone or in combination with the first aspect, process 1000 includes transmitting, to the network node, the multi-TRP SDT based at least in part on the multiple qualified beams indicated by the multi-TRP request message, or receiving, from the network node, the multi-TRP SDT based at least in part on the multiple qualified beams indicated by the multi-TRP request message.

In a third aspect, alone or in combination with one or more of the first and second aspects, process 1000 includes evaluating a plurality of SSBs associated with the plurality of beams, respectively, wherein the multi-TRP request message indicates qualified candidate SSB indices associated with the multiple qualified beams.

In a fourth aspect, alone or in combination with one or more of the first through third aspects, process 1000 includes transmitting the multi-TRP request message based at least in part on a best beam, of the plurality of beams, not satisfying a threshold.

In a fifth aspect, alone or in combination with one or more of the first through fourth aspects, process 1000 includes transmitting the multi-TRP request message based at least in part on a quantity of failed downlink transmissions satisfying a threshold.

In a sixth aspect, alone or in combination with one or more of the first through fifth aspects, process 1000 includes performing the multi-TRP SDT based at least in part on one or more of a UE capability of supporting multi-TRP SDTs in one or more physical channels, reporting measurements of downlink reference signaling associated with the plurality of beams not satisfying a first threshold, a quantity of failed uplink transmissions satisfying a second threshold, or the multi-TRP request message indicating the multiple qualified beams and an activation or deactivation request.

In a seventh aspect, alone or in combination with one or more of the first through sixth aspects, process 1000 includes performing the multi-TRP SDT based at least in part on a TDM, an FDM, or an SDM depending on whether the multiple qualified beams are reported in separate groups.

In an eighth aspect, alone or in combination with one or more of the first through seventh aspects, process 1000 includes receiving, from the network node, an indication of a single beam to disable multi-TRP SDTs for the UE.

In a ninth aspect, alone or in combination with one or more of the first through eighth aspects, process 1000 includes receiving, from the network node, DCI or a TCI state activation MAC-CE, wherein the DCI or the TCI state activation MAC-CE indicates a first beam that corresponds to a beam currently being used by the UE, and a second beam that corresponds to a new beam to be used for the multi-TRP SDT.

In a tenth aspect, alone or in combination with one or more of the first through ninth aspects, process 1000 includes receiving, from the network node, the configuration via dedicated signaling or broadcast signaling that configures multi-TRP resources.

In an eleventh aspect, alone or in combination with one or more of the first through tenth aspects, process 1000 includes receiving, from the network node, a CG SDT configuration that indicates one of a set of SSBs that are associated with one set of CG occasions, and one SSB is configured to be associated with two CG ant occasions, or two sets of SSBs that are associated with two sets of CG occasions.

In a twelfth aspect, alone or in combination with one or more of the first through eleventh aspects, process 1000 includes transmitting, to the network node, a UE capability that indicates whether the UE supports multi-TRP SDTs while operating in an RRC inactive state or an RRC idle state.

In a thirteenth aspect, alone or in combination with one or more of the first through twelfth aspects, the multi-TRP request message indicates a UE preference on whether to activate or deactivate a multi-TRP SDT operation.

In a fourteenth aspect, alone or in combination with one or more of the first through thirteenth aspects, the multi-TRP SDT is associated with a multi-TRP repetition for SDT, and the multi-TRP SDT is based at least in part on transmitting a same or repeated uplink data or signaling towards two TRPs, or the multi-TRP SDT is based at least in part on receiving a same or repeated downlink data or signaling from the two TRPs.

In a fifteenth aspect, alone or in combination with one or more of the first through fourteenth aspects, process 1000 includes receiving, from the network node and when operating in an RRC inactive state or an RRC idle state, a TRS configuration that indicates one or more TRS resources, wherein the multiple qualified beams are determined based at least in part on one or more TRSs associated with the one or more TRS resources.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with SDTs for multiple TRPs.

As shown in FIG. 11, in some aspects, process 1100 may include receiving, from a network node, an RRC release message that indicates a TRP resource or beam configuration, wherein the TRP resource or beam configuration indicates multiple beams associated with multiple TRPs of the network node, respectively (block 1110). For example, the UE (e.g., using communication manager 140 and/or reception component 1402, depicted in FIG. 14) may receive, from a network node, an RRC release message that indicates a TRP resource or beam configuration, wherein the TRP resource or beam configuration indicates multiple beams associated with multiple TRPs of the network node, respectively, as described above.

As further shown in FIG. 11, in some aspects, process 1100 may include performing, with the network node, a multi-TRP SDT based at least in part on the TRP resource or beam configuration (block 1120). For example, the UE (e.g., using communication manager 140, and/or reception component 1402 and/or transmission component 1404, depicted in FIG. 14) may perform, with the network node, a multi-TRP SDT based at least in part on the TRP resource or beam configuration, as described above.

Process 1100 may include additional aspects, such as any single aspect or any combination of aspects described below and/or in connection with one or more other processes described elsewhere herein.

In a first aspect, the TRP resource or beam configuration configures a set of more than two beams when the UE moves to an RRC inactive state, and process 1100 includes selecting two qualified beams, among the set of more than two beams, for the multi-TRP SDT.

In a second aspect, alone or in combination with the first aspect, process 1100 includes transmitting, to the network node, the multi-TRP SDT based at least in part on the multiple beams indicated by the TRP resource or beam configuration, or receiving, from the network node, the multi-TRP SDT based at least in part on the multiple beams indicated by the TRP resource or beam configuration.

In a third aspect, alone or in combination with one or more of the first and second aspects, process 1100 includes entering an RRC inactive state based at least in part on receiving the RRC release message, wherein the UE receives the RRC release message while operating in an RRC connected state, and two beams corresponding to two TRPs are already configured when the UE is in the RRC connected state or are configured in the RRC release message for the UE to use when performing the multi-TRP SDT in the RRC inactive state.

In a fourth aspect, alone or in combination with one or more of the first through third aspects, process 1100 includes receiving, from the network node, a network response that indicates a TCI state activation MAC-CE, wherein the TCI state activation MAC-CE indicates one or more updated beams for the multiple TRPs.

In a fifth aspect, alone or in combination with one or more of the first through fourth aspects, process 1100 includes performing the multi-TRP SDT based at least in part on multiple corresponding CG occasions associated with the multiple beams indicated by the TRP resource or beam configuration, or the UE falls back to select one corresponding CG occasion for SDT without a multi-TRP repetition based at least in part on the network node indicating only one beam.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with SDTs for multiple TRPs.

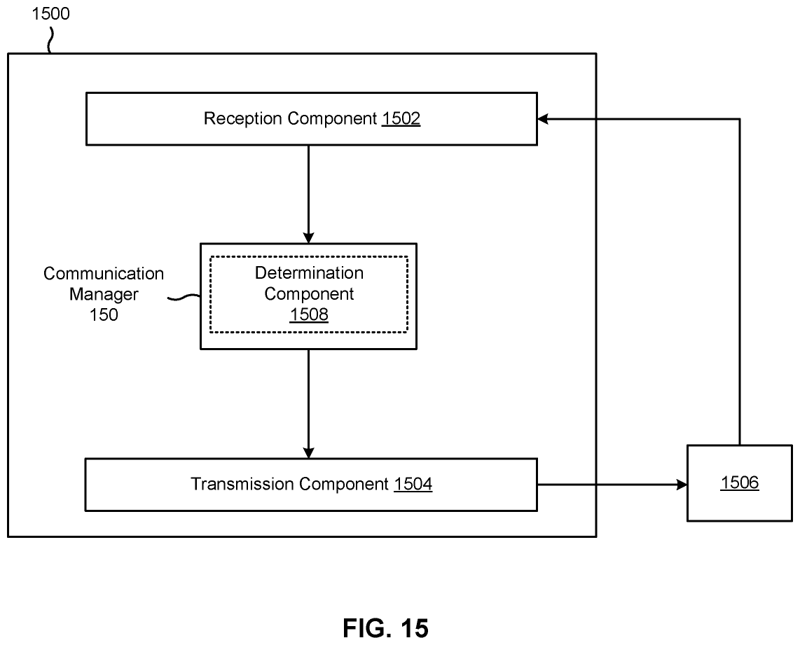

As shown in FIG. 12, in some aspects, process 1200 may include transmitting, to a UE, a configuration that indicates a plurality of beams (block 1210). For example, the network node (e.g., using communication manager 150 and/or transmission component 1504, depicted in FIG. 15) may transmit, to a UE, a configuration that indicates a plurality of beams, as described above.

As further shown in FIG. 12, in some aspects, process 1200 may include receiving, from the UE, a multi-TRP request message, wherein the multi-TRP request message indicates multiple qualified beams from the plurality of beams (block 1220). For example, the network node (e.g., using communication manager 150 and/or reception component 1502, depicted in FIG. 15) may receive, from the UE, a multi-TRP request message, wherein the multi-TRP request message indicates multiple qualified beams from the plurality of beams, as described above.

As further shown in FIG. 12, in some aspects, process 1200 may include performing, with the UE, a multi-TRP SDT based at least in part on the multiple qualified beams indicated by the multi-TRP request message (block 1230). For example, the network node (e.g., using communication manager 150, and/or reception component 1502 and/or transmission component 1504, depicted in FIG. 15) may perform, with the UE, a multi-TRP SDT based at least in part on the multiple qualified beams indicated by the multi-TRP request message, as described above.

Process 1200 may include additional aspects, such as any single aspect or any combination of aspects described below and/or in connection with one or more other processes described elsewhere herein.

In a first aspect, process 1200 includes determining to enable the multi-TRP SDT is based at least in part on one or more of a UE capability of supporting multi-TRP SDTs in one or more physical channels, reporting measurements of downlink reference signaling associated with the plurality of beams not satisfying a first threshold, a quantity of failed uplink transmissions satisfying a second threshold, or the multi-TRP request message indicating the multiple qualified beams and an activation or deactivation request.

In a second aspect, alone or in combination with the first aspect, process 1200 includes process 1200 includes performing the multi-TRP SDT based at least in part on a TDM, an FDM, or an SDM depending on whether the multiple qualified beams are reported in separate groups.

In a third aspect, alone or in combination with one or more of the first and second aspects, process 1200 includes transmitting, to the UE, DCI or a TCI state activation MAC-CE, wherein the DCI or the TCI state activation MAC-CE indicates a first beam that corresponds to a beam currently being used by the UE, and a second beam that corresponds to a new beam to be used for the multi-TRP SDT.

In a fourth aspect, alone or in combination with one or more of the first through third aspects, process 1200 includes receiving, from the UE, a UE capability that indicates whether the UE supports multi-TRP SDTs while operating in an RRC inactive state or an RRC idle state.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with SDTs for multiple TRPs.

As shown in FIG. 13, in some aspects, process 1300 may include transmitting, to a UE, an RRC release message that indicates a TRP resource or beam configuration, wherein the TRP resource or beam configuration indicates multiple beams associated with multiple TRPs of the network node, respectively (block 1310). For example, the network node (e.g., using communication manager 150 and/or transmission component 1504, depicted in FIG. 15) may transmit, to a UE, an RRC release message that indicates a TRP resource or beam configuration, wherein the TRP resource or beam configuration indicates multiple beams associated with multiple TRPs of the network node, respectively, as described above.

As further shown in FIG. 13, in some aspects, process 1300 may include performing, with the UE, a multi-TRP SDT based at least in part on the TRP resource or beam configuration (block 1320). For example, the network node (e.g., using communication manager 150, and/or reception component 1502 and/or transmission component 1504, depicted in FIG. 15) may perform, with the UE, a multi-TRP SDT based at least in part on the TRP resource or beam configuration, as described above.

Process 1300 may include additional aspects, such as any single aspect or any combination of aspects described below and/or in connection with one or more other processes described elsewhere herein.

In a first aspect, the TRP resource or beam configuration configures a set of more than two beams when the UE moves to an RRC inactive state, and two qualified beams are selected, among the set of more than two beams, for the multi-TRP SDT.

In a second aspect, alone or in combination with the first aspect, process 1300 includes receiving, from the network node, a network response that indicates a TCI state activation MAC-CE, wherein the TCI state activation MAC-CE indicates one or more updated beams for the multiple TRPs.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include one or more of an evaluation component 1408, or an entering component 1410, among other examples.

In some aspects, the apparatus 1400 may be configured to perform one or more operations described herein in connection with FIGS. 7-9. Additionally, or alternatively, the apparatus 1400 may be configured to perform one or more processes described herein, such as process 1000 of FIG. 10, process 1100 of FIG. 11, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive, from a network node, a configuration that indicates a plurality of beams. The transmission component 1404 may transmit, to the network node, a multi-TRP request message, wherein the multi-TRP request message indicates multiple qualified beams from the plurality of beams. The reception component 1402 and/or the transmission component 1404 may perform, with the network node, a multi-TRP SDT based at least in part on the multiple qualified beams indicated by the multi-TRP request message.

The evaluation component 1408 may evaluate a plurality of SSBs associated with the plurality of beams, respectively, wherein the multi-TRP request message indicates qualified candidate SSB indices associated with the multiple qualified beams. The reception component 1402 may receive, from the network node, an indication of a single beam to disable multi-TRP SDTs for the UE. The reception component 1402 may receive, from the network node, DCI or a TCI state activation MAC-CE, wherein the DCI or the TCI state activation MAC-CE indicates a first beam that corresponds to a beam currently being used by the UE, and a second beam that corresponds to a new beam to be used for the multi-TRP SDT.

The reception component 1402 may receive, from the network node, a CG SDT configuration that indicates one of a set of SSBs that are associated with one set of CG occasions, and one SSB is configured to be associated with two CG occasions; or two sets of SSBs that are associated with two sets of CG occasions. The transmission component 1404 may transmit, to the network node, a UE capability that indicates whether the UE supports multi-TRP SDTs while operating in an RRC inactive state or an RRC idle state. The reception component 1402 may receive, from the network node and when operating in an RRC inactive state or an RRC idle state, a TRS configuration that indicates one or more TRS resources, wherein the multiple qualified beams are determined based at least in part on one or more TRSs associated with the one or more TRS resources.

The reception component 1402 may receive, from a network node, an RRC release message that indicates a TRP resource or beam configuration, wherein the TRP resource or beam configuration indicates multiple beams associated with multiple TRPs of the network node, respectively. The reception component 1402 and/or the transmission component 1404 may perform, with the network node, a multi-TRP SDT based at least in part on the TRP resource or beam configuration.

The entering component 1410 may enter an RRC inactive state based at least in part on receiving the RRC release message, wherein the UE receives the RRC release message while operating in an RRC connected state, and two beams corresponding to two TRPs are already configured when the UE is in the RRC connected state or are configured in the RRC release message for the UE to use when performing the multi-TRP SDT in the RRC inactive state. The reception component 1402 may receive, from the network node, a network response that indicates a TCI state activation MAC-CE, wherein the TCI state activation MAC-CE indicates one or more updated beams for the multiple TRPs.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include a determination component 1508, among other examples.

In some aspects, the apparatus 1500 may be configured to perform one or more operations described herein in connection with FIGS. 7-9. Additionally, or alternatively, the apparatus 1500 may be configured to perform one or more processes described herein, such as process 1200 of FIG. 12, process 1300 of FIG. 13, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The transmission component 1504 may transmit, to a UE, a configuration that indicates a plurality of beams. The reception component 1502 may receive, from the UE, a multi-TRP request message, wherein the multi-TRP request message indicates multiple qualified beams from the plurality of beams. The reception component 1502 and/or the transmission component 1504 may perform, with the UE, a multi-TRP SDT based at least in part on the multiple qualified beams indicated by the multi-TRP request message.

The determination component 1508 may determine to enable the multi-TRP SDT is based at least in part on one or more of a UE capability of supporting multi-TRP SDTs in one or more physical channels; reported measurements of downlink reference signaling associated with the plurality of beams not satisfying a first threshold; a quantity of failed uplink transmissions satisfying a second threshold; or the multi-TRP request message indicating the multiple qualified beams and an activation or deactivation request. The transmission component 1504 may transmit, to the UE, DCI or a TCI state activation MAC-CE, wherein the DCI or the TCI state activation MAC-CE indicates a first beam that corresponds to a beam currently being used by the UE, and a second beam that corresponds to a new beam to be used for the multi-TRP SDT. The reception component 1502 may receive, from the UE, a UE capability that indicates whether the UE supports multi-TRP SDTs while operating in an RRC inactive state or an RRC idle state.

The transmission component 1504 may transmit, to a UE, an RRC release message that indicates a TRP resource or beam configuration, wherein the TRP resource or beam configuration indicates multiple beams associated with multiple TRPs of the network node, respectively. The reception component 1502 and/or the transmission component 1504 may perform, with the UE, a multi-TRP SDT based at least in part on the TRP resource or beam configuration. The reception component 1502 may receive, from the network node, a network response that indicates a TCI state activation MAC-CE, wherein the TCI state activation MAC-CE indicates one or more updated beams for the multiple TRPs.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving, from a network node, a configuration that indicates a plurality of beams; transmitting, to the network node, a multiple transmission reception point (TRP) (multi-TRP) request message, wherein the multi-TRP request message indicates multiple qualified beams from the plurality of beams; and performing, with the network node, a multi-TRP small data transmission (SDT) based at least in part on the multiple qualified beams indicated by the multi-TRP request message.

Aspect 2: The method of Aspect 1, wherein the UE is configured with a first beam for communication with a first TRP of multiple TRPs, wherein a selected beam from the multiple qualified beams is a second beam for communication with a second TRP of the multiple TRPs, and wherein the first beam and the second beam enable two transmission configuration indication states for a multi-TRP SDT operation.

Aspect 3: The method of any of Aspects 1 through 2, wherein performing the multi-TRP SDT comprises: transmitting, to the network node, the multi-TRP SDT based at least in part on the multiple qualified beams indicated by the multi-TRP request message; or receiving, from the network node, the multi-TRP SDT based at least in part on the multiple qualified beams indicated by the multi-TRP request message.

Aspect 4: The method of any of Aspects 1 through 3, further comprising: evaluating a plurality of synchronization signal blocks (SSBs) associated with the plurality of beams, respectively, wherein the multi-TRP request message indicates qualified candidate SSB indices associated with the multiple qualified beams.

Aspect 5: The method of any of Aspects 1 through 4, wherein transmitting the multi-TRP request message is based at least in part on a best beam, of the plurality of beams, not satisfying a threshold.

Aspect 6: The method of any of Aspects 1 through 5, wherein transmitting the multi-TRP request message is based at least in part on a quantity of failed downlink transmissions satisfying a threshold.

Aspect 7: The method of any of Aspects 1 through 6, wherein performing the multi-TRP SDT is based at least in part on one or more of: a UE capability of supporting multi-TRP SDTs in one or more physical channels; reported measurements of downlink reference signaling associated with the plurality of beams not satisfying a first threshold; a quantity of failed uplink transmissions satisfying a second threshold; or the multi-TRP request message indicating the multiple qualified beams and an activation or deactivation request.

Aspect 8: The method of any of Aspects 1 through 7, wherein performing the multi-TRP SDT is based at least in part on a time division multiplexing, a frequency division multiplexing, or a spatial division multiplexing depending on whether the multiple qualified beams are reported in separate groups.

Aspect 9: The method of any of Aspects 1 through 8, further comprising: receiving, from the network node, an indication of a single beam to disable multi-TRP SDTs for the UE.

Aspect 10: The method of any of Aspects 1 through 9, further comprising: receiving, from the network node, downlink control information (DCI) or a transmission configuration indication (TCI) state activation medium access control control element (MAC-CE), wherein the DCI or the TCI state activation MAC-CE indicates a first beam that corresponds to a beam currently being used by the UE, and a second beam that corresponds to a new beam to be used for the multi-TRP SDT.

Aspect 11: The method of any of Aspects 1 through 10, wherein receiving the configuration comprises receiving, from the network node, the configuration via dedicated signaling or broadcast signaling that configures multi-TRP resources.

Aspect 12: The method of any of Aspects 1 through 11, further comprising: receiving, from the network node, a configured grant SDT configuration that indicates one of: a set of synchronization signal blocks (SSBs) that are associated with one set of configured grant occasions, and one SSB is configured to be associated with two configured grant occasions; or two sets of SSBs that are associated with two sets of configured grant occasions.

Aspect 13: The method of any of Aspects 1 through 12, further comprising: transmitting, to the network node, a UE capability that indicates whether the UE supports multi-TRP SDTs while operating in a radio resource control (RRC) inactive state or an RRC idle state.

Aspect 14: The method of any of Aspects 1 through 13, wherein the multi-TRP request message indicates a UE preference on whether to activate or deactivate a multi-TRP SDT operation.

Aspect 15: The method of any of Aspects 1 through 14, wherein the multi-TRP SDT is associated with a multi-TRP repetition for SDT, and wherein the multi-TRP SDT is based at least in part on transmitting a same or repeated uplink data or signaling towards two TRPs, or the multi-TRP SDT is based at least in part on receiving a same or repeated downlink data or signaling from the two TRPs.

Aspect 16: The method of any of Aspects 1 through 15, further comprising: receiving, from the network node and when operating in a radio resource control (RRC) inactive state or an RRC idle state, a tracking reference signal (TRS) configuration that indicates one or more TRS resources, wherein the multiple qualified beams are determined based at least in part on one or more TRSs associated with the one or more TRS resources.

Aspect 17: A method of wireless communication performed by a user equipment (UE), comprising: receiving, from a network node, a radio resource control (RRC) release message that indicates a transmission reception point (TRP) resource or beam configuration, wherein the TRP resource or beam configuration indicates multiple beams associated with multiple TRPs of the network node, respectively; and performing, with the network node, a multiple TRP (multi-TRP) small data transmission (SDT) based at least in part on the TRP resource or beam configuration.

Aspect 18: The method of Aspect 17, wherein the TRP resource or beam configuration configures a set of more than two beams when the UE moves to a radio resource control inactive state, and further comprising selecting two qualified beams, among the set of more than two beams, for the multi-TRP SDT.

Aspect 19: The method of any of Aspects 17 through 18, wherein performing the multi-TRP SDT comprises: transmitting, to the network node, the multi-TRP SDT based at least in part on the multiple beams indicated by the TRP resource or beam configuration; or receiving, from the network node, the multi-TRP SDT based at least in part on the multiple beams indicated by the TRP resource or beam configuration.

Aspect 20: The method of any of Aspects 17 through 19, further comprising: entering an RRC inactive state based at least in part on receiving the RRC release message, wherein the UE receives the RRC release message while operating in an RRC connected state, and wherein two beams corresponding to two TRPs are already configured when the UE is in the RRC connected state or are configured in the RRC release message for the UE to use when performing the multi-TRP SDT in the RRC inactive state.

Aspect 21: The method of any of Aspects 17 through 20, further comprising: receiving, from the network node, a network response that indicates a transmission configuration indication (TCI) state activation medium access control control element (MAC-CE), wherein the TCI state activation MAC-CE indicates one or more updated beams for the multiple TRPs.

Aspect 22: The method of any of Aspects 17 through 21, wherein performing the multi-TRP SDT is based at least in part on multiple corresponding configured grant occasions associated with the multiple beams indicated by the TRP resource or beam configuration, or the UE falls back to select one corresponding configured grant occasion for SDT without a multi-TRP repetition based at least in part on the network node indicating only one beam.

Aspect 23: A method of wireless communication performed by a network node, comprising: transmitting, to a user equipment (UE), a configuration that indicates a plurality of beams; receiving, from the UE, a multiple transmission reception point (TRP) (multi-TRP) request message, wherein the multi-TRP request message indicates multiple qualified beams from the plurality of beams; and performing, with the UE, a multi-TRP small data transmission (SDT) based at least in part on the multiple qualified beams indicated by the multi-TRP request message.

Aspect 24: The method of Aspect 23, further comprising: determining to enable the multi-TRP SDT is based at least in part on one or more of: a UE capability of supporting multi-TRP SDTs in one or more physical channels; reported measurements of downlink reference signaling associated with the plurality of beams not satisfying a first threshold; a quantity of failed uplink transmissions satisfying a second threshold; or the multi-TRP request message indicating the multiple qualified beams and an activation or deactivation request.

Aspect 25: The method of any of Aspects 23 through 24, wherein performing the multi-TRP SDT is based at least in part on a time division multiplexing, a frequency division multiplexing, or a spatial division multiplexing depending on whether the multiple qualified beams are reported in separate groups.

Aspect 26: The method of any of Aspects 23 through 25, further comprising: transmitting, to the UE, downlink control information (DCI) or a transmission configuration indication (TCI) state activation medium access control control element (MAC-CE), wherein the DCI or the TCI state activation MAC-CE indicates a first beam that corresponds to a beam currently being used by the UE, and a second beam that corresponds to a new beam to be used for the multi-TRP SDT.

Aspect 27: The method of any of Aspects 23 through 26, further comprising: receiving, from the UE, a UE capability that indicates whether the UE supports multi-TRP SDTs while operating in a radio resource control (RRC) inactive state or an RRC idle state.

Aspect 28: A method of wireless communication performed by a network node, comprising: transmitting, to a user equipment (UE), a radio resource control (RRC) release message that indicates a transmission reception point (TRP) resource or beam configuration, wherein the TRP resource or beam configuration indicates multiple beams associated with multiple TRPs of the network node, respectively; and performing, with the UE, a multiple TRP (multi-TRP) small data transmission (SDT) based at least in part on the TRP resource or beam configuration.

Aspect 29: The method of Aspect 28, wherein the TRP resource or beam configuration configures a set of more than two beams when the UE moves to a radio resource control inactive state, and wherein two qualified beams are selected, among the set of more than two beams, for the multi-TRP SDT.

Aspect 30: The method of any of Aspects 28 through 29, further comprising: receiving, from the network node, a network response that indicates a transmission configuration indication (TCI) state activation medium access control control element (MAC-CE), wherein the TCI state activation MAC-CE indicates one or more updated beams for the multiple TRPs.

Aspect 31: An apparatus for wireless communication at a device, comprising a processor; memory coupled with the processor; and instructions stored in the memory and executable by the processor to cause the apparatus to perform the method of one or more of Aspects 1-22.

Aspect 32: A device for wireless communication, comprising a memory and one or more processors coupled to the memory, the one or more processors configured to perform the method of one or more of Aspects 1-22.

Aspect 33: An apparatus for wireless communication, comprising at least one means for performing the method of one or more of Aspects 1-22.

Aspect 34: A non-transitory computer-readable medium storing code for wireless communication, the code comprising instructions executable by a processor to perform the method of one or more of Aspects 1-22.

Aspect 35: A non-transitory computer-readable medium storing a set of instructions for wireless communication, the set of instructions comprising one or more instructions that, when executed by one or more processors of a device, cause the device to perform the method of one or more of Aspects 1-22.

Aspect 36: An apparatus for wireless communication at a device, comprising a processor; memory coupled with the processor; and instructions stored in the memory and executable by the processor to cause the apparatus to perform the method of one or more of Aspects 23-30.

Aspect 37: A device for wireless communication, comprising a memory and one or more processors coupled to the memory, the one or more processors configured to perform the method of one or more of Aspects 23-30.

Aspect 38: An apparatus for wireless communication, comprising at least one means for performing the method of one or more of Aspects 23-30.

Aspect 39: A non-transitory computer-readable medium storing code for wireless communication, the code comprising instructions executable by a processor to perform the method of one or more of Aspects 23-30.

Aspect 40: A non-transitory computer-readable medium storing a set of instructions for wireless communication, the set of instructions comprising one or more instructions that, when executed by one or more processors of a device, cause the device to perform the method of one or more of Aspects 23-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
receive, from a network node, a configuration that indicates a plurality of beams;
transmit, to the network node, a multiple transmission reception point (TRP) (multi-TRP) request message, wherein the multi-TRP request message indicates multiple qualified beams from the plurality of beams; and
perform, with the network node, a multi-TRP small data transmission (SDT) based at least in part on the multiple qualified beams indicated by the multi-TRP request message.

2. The apparatus of 1, wherein the UE is configured with a first beam for communication with a first TRP of multiple TRPs, wherein a selected beam from the multiple qualified beams is a second beam for communication with a second TRP of the multiple TRPs, and wherein the first beam and the second beam enable two transmission configuration indication states for a multi-TRP SDT operation.

3. The apparatus of claim 1, wherein the one or more processors, to perform the multi-TRP SDT, are configured to:
transmit, to the network node, the multi-TRP SDT based at least in part on the multiple qualified beams indicated by the multi-TRP request message; or
receive, from the network node, the multi-TRP SDT based at least in part on the multiple qualified beams indicated by the multi-TRP request message.

4. The apparatus of claim 1, wherein the one or more processors are further configured to:
evaluate a plurality of synchronization signal blocks (SSBs) associated with the plurality of beams, respectively, wherein the multi-TRP request message indicates qualified candidate SSB indices associated with the multiple qualified beams.

5. The apparatus of claim 1, wherein the one or more processors are configured to transmit the multi-TRP request message based at least in part on a best beam, of the plurality of beams, not satisfying a threshold.

6. The apparatus of claim 1, wherein the one or more processors are configured to transmit the multi-TRP request message based at least in part on a quantity of failed downlink transmissions satisfying a threshold.

7. The apparatus of claim 1, wherein the one or more processors are configured to perform the multi-TRP SDT based at least in part on one or more of:
a UE capability of supporting multi-TRP SDTs in one or more physical channels;
reported measurements of downlink reference signaling associated with the plurality of beams not satisfying a first threshold;
a quantity of failed uplink transmissions satisfying a second threshold; or
the multi-TRP request message indicating the multiple qualified beams and an activation or deactivation request.

8. The apparatus of claim 1, wherein the one or more processors are configured to perform the multi-TRP SDT based at least in part on a time division multiplexing, a frequency division multiplexing, or a spatial division multiplexing depending on whether the multiple qualified beams are reported in separate groups.

9. The apparatus of claim 1, wherein the one or more processors are further configured to:
receive, from the network node, an indication of a single beam to disable multi-TRP SDTs for the UE.

10. The apparatus of claim 1, wherein the one or more processors are further configured to:
receive, from the network node, downlink control information (DCI) or a transmission configuration indication (TCI) state activation medium access control control element (MAC-CE), wherein the DCI or the TCI state activation MAC-CE indicates a first beam that corresponds to a beam currently being used by the UE, and a second beam that corresponds to a new beam to be used for the multi-TRP SDT.

11. The apparatus of claim 1, wherein the one or more processors, to receive the configuration, are configured to:
receive, from the network node, the configuration via dedicated signaling or broadcast signaling that configures multi-TRP resources.

12. The apparatus of claim 1, wherein the one or more processors are further configured to:
receive, from the network node, a configured grant SDT configuration that indicates one of:
a set of synchronization signal blocks (SSBs) that are associated with one set of configured grant occasions, and one SSB is configured to be associated with two configured grant occasions; or
two sets of SSBs that are associated with two sets of configured grant occasions.

13. The apparatus of claim 1, wherein the one or more processors are further configured to:
transmit, to the network node, a UE capability that indicates whether the UE supports multi-TRP SDTs while operating in a radio resource control (RRC) inactive state or an RRC idle state.

14. The apparatus of claim 1, wherein the multi-TRP request message indicates a UE preference on whether to activate or deactivate a multi-TRP SDT operation.

15. The apparatus of claim 1, wherein the multi-TRP SDT is associated with a multi-TRP repetition for SDT, and wherein the multi-TRP SDT is based at least in part on transmitting a same or repeated uplink data or signaling towards two TRPs, or the multi-TRP SDT is based at least in part on receiving a same or repeated downlink data or signaling from the two TRPs.

16. The apparatus of claim 1, wherein the one or more processors are further configured to:
receive, from the network node and when operating in a radio resource control (RRC) inactive state or an RRC idle state, a tracking reference signal (TRS) configuration that indicates one or more TRS resources, wherein the multiple qualified beams are determined based at least in part on one or more TRSs associated with the one or more TRS resources.

17. An apparatus for wireless communication at a user equipment (UE), comprising:
a memory; and
one or more processors, coupled to the memory, configured to:
receive, from a network node, a radio resource control (RRC) release message that indicates a transmission reception point (TRP) resource or beam configuration, wherein the TRP resource or beam configuration indicates multiple beams associated with multiple TRPs of the network node, respectively; and
perform, with the network node, a multiple TRP (multi-TRP) small data transmission (SDT) based at least in part on the TRP resource or beam configuration.

18. The apparatus of claim 17, wherein the TRP resource or beam configuration configures a set of more than two beams when the UE moves to a radio resource control inactive state, and wherein the one or more processors are further configured to select two qualified beams, among the set of more than two beams, for the multi-TRP SDT.

19. The apparatus of claim 17, wherein the one or more processors, to perform the multi-TRP SDT, are configured to:
transmit, to the network node, the multi-TRP SDT based at least in part on the multiple beams indicated by the TRP resource or beam configuration; or
receive, from the network node, the multi-TRP SDT based at least in part on the multiple beams indicated by the TRP resource or beam configuration.

20. The apparatus of claim 17, wherein the one or more processors are further configured to:
enter an RRC inactive state based at least in part on receiving the RRC release message, wherein the UE receives the RRC release message while operating in an RRC connected state, and wherein two beams corresponding to two TRPs are already configured when the UE is in the RRC connected state or are configured in the RRC release message for the UE to use when performing the multi-TRP SDT in the RRC inactive state.

21. The apparatus of claim 17, wherein the one or more processors are further configured to:
receive, from the network node, a network response that indicates a transmission configuration indication (TCI) state activation medium access control control element (MAC-CE), wherein the TCI state activation MAC-CE indicates one or more updated beams for the multiple TRPs.

22. The apparatus of claim 17, wherein the one or more processors are configured to perform the multi-TRP SDT based at least in part on multiple corresponding configured grant occasions associated with the multiple beams indicated by the TRP resource or beam configuration, or the UE falls back to select one corresponding configured grant occasion for SDT without a multi-TRP repetition based at least in part on the network node indicating only one beam.

23. An apparatus for wireless communication at a network node, comprising:
a memory; and
one or more processors, coupled to the memory, configured to:
transmit, to a user equipment (UE), a configuration that indicates a plurality of beams;
receive, from the UE, a multiple transmission reception point (TRP) (multi-TRP) request message, wherein the multi-TRP request message indicates multiple qualified beams from the plurality of beams; and
perform, with the UE, a multi-TRP small data transmission (SDT) based at least in part on the multiple qualified beams indicated by the multi-TRP request message.

24. The apparatus of claim 23, wherein the one or more processors are further configured to:
determine to enable the multi-TRP SDT is based at least in part on one or more of:
a UE capability of supporting multi-TRP SDTs in one or more physical channels;
reported measurements of downlink reference signaling associated with the plurality of beams not satisfying a first threshold;
a quantity of failed uplink transmissions satisfying a second threshold; or
the multi-TRP request message indicating the multiple qualified beams and an activation or deactivation request.

25. The apparatus of claim 23, wherein the one or more processors are configured to perform the multi-TRP SDT based at least in part on a time division multiplexing, a frequency division multiplexing, or a spatial division multiplexing depending on whether the multiple qualified beams are reported in separate groups.

26. The apparatus of claim 23, wherein the one or more processors are further configured to:
transmit, to the UE, downlink control information (DCI) or a transmission configuration indication (TCI) state activation medium access control control element (MAC-CE), wherein the DCI or the TCI state activation MAC-CE indicates a first beam that corresponds to a beam currently being used by the UE, and a second beam that corresponds to a new beam to be used for the multi-TRP SDT.

27. The apparatus of claim 23, wherein the one or more processors are further configured to:
receive, from the UE, a UE capability that indicates whether the UE supports multi-TRP SDTs while operating in a radio resource control (RRC) inactive state or an RRC idle state.

28. An apparatus for wireless communication at a network node, comprising:
a memory; and
one or more processors, coupled to the memory, configured to:
transmit, to a user equipment (UE), a radio resource control (RRC) release message that indicates a transmission reception point (TRP) resource or beam configuration, wherein the TRP resource or beam configuration indicates multiple beams associated with multiple TRPs of the network node, respectively; and
perform, with the UE, a multiple TRP (multi-TRP) small data transmission (SDT) based at least in part on the TRP resource or beam configuration.

29. The apparatus of claim 28, wherein the TRP resource or beam configuration configures a set of more than two beams when the UE moves to a radio resource control inactive state, and wherein two qualified beams are selected, among the set of more than two beams, for the multi-TRP SDT.

30. The apparatus of claim 28, wherein the one or more processors are further configured to:
receive, from the network node, a network response that indicates a transmission configuration indication (TCI) state activation medium access control control element (MAC-CE), wherein the TCI state activation MAC-CE indicates one or more updated beams for the multiple TRPs.
